(19) United States
(12) Patent Application Publication
(10) Pub. No.: US 2026/0290916 A1
(43) Pub. Date: Sep. 24, 2026

(54) METHOD AND APPARATUS FOR IMAGING ELECTROCHEMICAL CELL ELECTRODES

(71) Applicant: ILLUMION LTD, Altrincham, Cheshire (GB)

(72) Inventors: Christoph SCHNEDERMANN, Altrincham, Cheshire (GB); Alice Jane MERRYWEATHER, Altrincham, Cheshire (GB); Guilherme NETTESHEIM, Altrincham, Cheshire (GB); Jiho HAN, Altrincham, Cheshire (GB)

(73) Assignee: ILLUMION LTD, Altrincham, Cheshire (GB)

(21) Appl. No.: 19/484,391

(22) PCT Filed: May 16, 2024
(86) PCT No.: PCT/GB2024/051279

§ 371 Date: Nov. 14, 2025

(30) Foreign Application Priority Data
May 16, 2023 (GB) 2307276.2

(51) Int. Cl. H01M 10/42; G01N 21/88; G01N 21/956; G02B 21/00; H01M 10/48; H01M 50/109; H01M 50/126; H01M 50/131

(52) U.S. Cl. CPC H01M 10/4285; G01N 21/8806; G01N 21/95684; G02B 21/0032; H01M 10/488; H01M 50/109; H01M 50/126; H01M 50/131

(57) ABSTRACT

An electrochemical cell is provided. The electrochemical cell comprising: a working electrode; a transparent window configured to provide optical access to the working electrode; and a partially reflective layer comprising one or more regions configured to reflect electromagnetic radiation and one or more regions configured to transmit electromagnetic radiation, wherein the partially reflective layer is in mechanical communication with the working electrode and configured to change in a manner indicative of a corresponding change in the working electrode; and wherein the working electrode is substantially in continuous contact with either the transparent window or the partially reflective layer.

### FIELD OF THE INVENTION

The invention relates to a method and apparatus for imaging electrodes. In particular, but not exclusively, the invention relates to imaging electrochemical cell electrodes in an optically accessible electrochemical cell, using optical microscopy, during an electrochemical process.

### BACKGROUND

In order to advance battery technologies, such as those based on lithium-ion batteries, it is helpful to understand how battery materials function on the nano- to mesoscale during real-time operation. For example, it has been demonstrated that optical measurements of electrochemical cell electrodes during electrochemical processes (such as charging and discharging) can provide useful mechanistic information (Merryweather et al., Nature, Vol. 594, 2021, pages 522 to 528). In contrast to previous methods for operando imaging of lithium-ion dynamics, based on sophisticated synchrotron X-ray or electron microscopy techniques, the use of an optical scattering microscope has been shown to resolve nanoscopic lithium-ion dynamics in battery materials in an elegant manner suitable for high-throughput analysis.

However, whilst charging, discharging and degradation mechanisms relating to individual particles (e.g., particles of LiₓCoO₂) within an electrode matrix have been investigated in such experiments, previous studies into such electrochemical processes have been limited to dilute electrodes. In this context, the term “dilute” is used as an umbrella term including porous, self-standing electrodes with a relatively low density of active material particles, such as, LiₓCoO₂, compared with conventional electrodes having a relatively high density of active material particles. The relatively sparse distribution of active material particles within an inactive matrix means that changes to the active material particles during electrochemical processes, such as charge-discharge operations, can be monitored with reference to the inactive matrix. For example, a reference laser beam directed onto the inactive matrix, with a spot size that can be positioned between active material particles, can be used as a reference point to adjust the image focus of imaging apparatus, in order to account for any change in position of the electrode surface during electrochemical processes. For example, the use of a reference laser beam with a spot size of 8 to 15 microns at full-width-half-maximum means that the spot is much larger than the roughness of the inactive matrix in the region between active material particles, thus providing a clear reflection. In contrast, where the active material particles are densely packed, such as in conventional electrodes, the surface of the electrode is too rough to apply such a technique as the spacing between active material particles is less than the spot size of such a laser beam. Further, changes in the active particles during electrochemical processes means that the surface of such densely packed conventional electrodes does not provide a consistent reflection that can be used to aid the adjustment of image focus during the electrochemical processes.

In order to perform optical measurements on dilute electrodes during their operation, a relatively complex operando cell apparatus can be used. FIG. 1A shows an exploded-view arrangement of an exemplary prior art system 100 for analysing the electrochemical performance of a dilute electrochemical cell electrode 104 by scattering microscopy. The system 100 comprises an optical apparatus 120 that is used to interrogate a dilute electrochemical cell electrode 104 in an operando cell apparatus. The operando cell apparatus includes an optical window 102 within a lower casing 101, the optical window 102 providing optical access to the dilute electrode 104. The dilute electrode 104 is a free-standing electrode of Lithium Cobalt Oxide (LCO) powder distributed in a polymer-based matrix. The free-standing dilute electrode 104 is in electrical contact with an aluminium mesh 106, which is, in turn, in electrical contact with a probe 108 to forming the working electrode. The aluminium mesh 106 is separated, by a separator 110, from a lithium metal material 111 and further probe 112, which together form the counter electrode. An upper casing 103 cooperates with the lower casing 101 to seal the half-cell stack, which is wetted with a standard lithium hexafluorophosphate (LiPF₆) and carbonate liquid electrolyte (LP30).

The optical apparatus 120 comprises a laser diode as a light source 122 that is directed through the optical window 102 of the operando cell apparatus, as shown by an arrow 114. Prior to passing through the optical window 102, the light will have passed through a series of optical components, including a lens 124, polarizing beam splitter 126, quarter wave plate 128 and objective 130. The light source 122 is used to illuminate the dilute electrode 104 and the optical components are arranged such that incident light is focused on an active particle in the dilute electrode 104 and the light subsequently scattered by the active particle is collected via a further lens 132, such that the collected light is imaged at a complementary metal oxide semiconductor (CMOS) camera 134. Such a system enables the dilute electrochemical cell electrode to be imaged whilst the desired current-voltage conditions are applied to the operando cell apparatus.

The operando cell apparatus described above, whilst modular and re-usable, is unsuitable for routine battery testing because it is considered to be relatively expensive, difficult to assemble and to have unreliable cycling performance.

In order to improve understanding of the processes during real-time operation of conventional electrochemical cells, such as coin cells, it would be beneficial optically to interrogate conventional electrochemical cells during electrochemical processes. In particular, it would be beneficial optically to interrogate dense, conventional electrochemical cell electrodes during electrochemical processes.

FIG. 1B shows a cross-sectional view of a conventional electrochemical coin cell 200 of the prior art. Within the coin cell 200 there is shown a stack of layers including a foil layer 204 upon which a working electrode layer 206 is positioned. The foil layer 204 is in electrical contact with a first part of the casing 202 of the coin cell 200.

The working electrode layer 206 is separated from a counter electrode 210 by a separator 208. In between the counter electrode 210 and a second part of the cell casing 216 there is a spacer layer 212 and a spring 214. Conventional electrochemical coin cells are not optically accessible, not least since both the first part of the casing 202 and the foil layer 204 are optically opaque, thereby preventing optical access to one planar face of the working electrode layer 206. Additionally, the separator 208, counter electrode 210, spacer layer 212 and the second part of the casing 216 prevent optical access to the other planar face, opposite the planar face of the working electrode layer 206 that is adjacent to the foil layer 204.

As described above, not only do such conventional electrochemical cells not provide optical access to the active material, even if they did, the rough surface of dense electrochemical cell electrodes due to the high density of active material particles is difficult to image in real time compared to the relatively low density of active material particles in dilute electrodes, as changes to the high density of active material particles during operation cannot be tracked with reference to an inactive matrix, as is possible with dilute electrochemical cell electrodes.

Further, if the arrangement of the mesh layer 106 and the dilute electrochemical electrode 104 described with reference to FIG. 1A were replaced with a densely packed conventional electrochemical cell electrode cast on a foil layer, electrolyte within such an operando cell could not penetrate the conventional foil layer to reach the active material of the electrochemical cell electrode. This contrasts with the free-standing dilute electrochemical cell electrode of the prior art, which is porous (and does not include a foil layer), thereby enabling electrolyte access to the sparsely distributed active material particles with the free-standing matrix.

In addition, it is known in the art to provide an electrochemical cell where the electrode is accessible through a gap or hole in a current collector. In this configuration, the working electrode is not in continuous contact with either the transparent window or the partially reflective layer. Typically, the current collector foil that is used can have a thickness of more than 15 μm, but it also has a high surface roughness of more than 500 nm peak to peak, which is a large variation. A high surface roughness of the working electrode can make it difficult to find a flat region for the autofocus beam to reflect off in a reliable fashion. If the surface is not flat, the spot that is imaged for the focus adjustment becomes structured, which in turn means that any small changes in horizontal and/or vertical (X,Y) direction of the microscope could be interpreted as a false focus shift.

Hence, there is a desire to provide an electrochemical cell with a working electrode having low surface roughness to reflect the autofocus beam in a more reliable, consistent, and efficient manner during an electrochemical process, to improve the imaging quality of the working electrode.

It is against this background that the present invention has arisen.

### SUMMARY OF INVENTION

In order to mitigate for at least some of the above-described problems, there is provided an electrochemical cell comprising: a working electrode; a transparent window configured to provide optical access to the working electrode; and a partially reflective layer comprising one or more regions configured to reflect electromagnetic radiation and one or more regions configured to transmit electromagnetic radiation, wherein the partially reflective layer is in mechanical communication with the working electrode and configured to change in a manner indicative of a corresponding change in the working electrode; and wherein the working electrode is substantially in continuous contact with either the transparent window or the partially reflective layer.

Within the context of the present invention and unless otherwise specified, the “working electrode” comprises an active material layer or particles for an electrochemical process or reaction to occur. The working electrode does not include a current collector, which can be made out of mesh or foil.

Within the context of the present invention, the term ‘continuous contact’ should be understood to mean that the working electrode is in contact at all points along its lower surface. In other words, the contact between the working electrode and the transparent window or the partially reflective layer is non-discontinuous such that a lower surface of the working electrode is always continuously in contact with one of the surfaces of the transparent window or the reflective layer.

As disclosed herein and unless otherwise specified, the continuous contact between the working electrode with the transparent window or the reflective layer means that there are no interruptions in contact on a macroscopic level for example, there are no intervals, gaps, spaces, ports or holes in between the layers that interrupts the contact between the transparent window or reflective layer with the working electrode.

Across the full extent of the working electrode, there will be contact with the transparent window in some parts and the reflective layer in other parts. There are no gaps in contact of the working electrode. No part of the working electrode is simultaneously in contact with both the transparent window and the reflective layer. The working electrode may be in any structural form or pattern known to the skilled person. For example, the working electrode may comprise one or more trenches or wells within its structure.

In some embodiments, the working electrode may have a substantially solid continuous contact throughout with either the transparent window or the reflective layer. In contrast, there are known electrochemical cell configurations in which the working electrode is optically accessible via a hole in the current collector. This hole may be filled with either a gas or a fluid electrolyte, and thus the working electrode is not in continuous contact with the transparent window or the current collector. In some embodiments, the working electrode may have an indirect or direct solid mechanical contact with the partially reflective layer. Advantageously, a continuous contact between the working electrode and the transparent window or the reflective layer may allow inference of the working electrode position using the reflective layer.

The electrochemical cell as disclosed herein can be made without any holes or ports between the working electrode and the transparent window or the reflective layer. This can be particularly advantageous since the cell of the invention as disclosed herein can be more robust and have high rigidity, which provides greater stability to the structural integrity of the device.

Moreover, the electrochemical cell as disclosed herein with continuous contact between the working electrode and the reflective layer or the transparent window can make the manufacturing processes easier and therefore, more cost-effective.

In another aspect of the present invention, there may be provided an electrochemical cell comprising: a working electrode; a transparent window configured to provide optical access to the working electrode; and a partially reflective layer comprising one or more regions configured to reflect electromagnetic radiation and one or more regions configured to transmit electromagnetic radiation, wherein the partially reflective layer is in mechanical communication with the working electrode and configured to change in a manner indicative of a corresponding change in the working electrode.

Advantageously, the electrochemical cell is optically accessible such that a portion of the working electrode comprising active material particles can be imaged in an improved manner during an electrochemical process. Beneficially, physical changes in the working electrode, such as changes in position due to swelling and contraction during electrochemical processes cause physical changes in the position of the partially reflective layer and hence the reflection interface formed at the partially reflective layer.

In some embodiments, changes in the reflection interface can be monitored such to provide improved imaging of the working electrode during operation of the electrochemical cell.

The partially reflective layer may be positioned at least partially between the transparent window and the working electrode. Beneficially, such positioning provides a smooth surface for reflecting a reference beam for autofocussing of images of the working electrode during an electrochemical process, where the surface is in close proximity to the surface of the working electrode for improved mechanical communication and imaging.

In some embodiments, autofocussing the beam position such that the focus remains constant throughout electrochemical cycling is critical for achieving improved imaging of the working electrode during operation of the electrochemical cell. In some embodiments, the working electrode is substantially in continuous contact with either the transparent window or the partially reflective layer. This can be important to ensure the reference beam can be directly correlated to the working electrode position.

The transparent window may be positioned at least partially between the partially reflective layer and the working electrode. Advantageously, such positioning on an external surface of the transparent window provides benefits in the manufacturing of optically accessible electrochemical cells, the type of material that can be used for the partially reflective layer, and the range of imaging techniques that can be used to image the working electrode.

The partially reflective layer may be at least partially embedded in the working electrode. Advantageously, the material of the working electrode layer is at least partially formed in the areas between reflective portions of the partially reflective layer, such that the working electrode layer can be in direct mechanical contact with the transparent window.

The partially reflective layer may comprise one or more apertures corresponding to the one or more regions configured to transmit electromagnetic radiation, thereby to provide optical access through the partially reflective layer to the working electrodes. The partially reflective layer may be a foil and/or mesh layer. Beneficially, the partially reflective surface simultaneously enables the working electrode to be imaged whilst providing a surface for reflection reference point for dynamic autofocussing.

The electrochemical cell may comprise one or more layers positioned between the partially reflective layer and the transparent window. Advantageously, additional layers provide improved functionality whilst facilitating imaging of the working electrode.

In some embodiments, the transparent window may comprise a passivation layer which may be provided in the part of the transparent window adjacent the partially reflective layer and the working electrode so that it can be substantially in continuous contact with the partially reflective layer and/or the working electrode. Providing a passivation layer as part of the transparent window can prevent or significantly minimise chemical and/or electrochemical changes in the partially reflective layer during the electrochemical cycling due to lithiation and/or redox reactions.

In some embodiments the passivation layer may be optically transparent. In some embodiments, the passivation layer may be electrochemically inert. In some embodiments, the passivation layer may be an oxide, including but not limited to, silicon dioxide, aluminium oxide, hafnium dioxide, or titanium dioxide. In some embodiments, the passivation layer may be a polymer, including but not limited to, poly(methyl methacrylate) (PMMA).

In some embodiments, the passivation layer may be less than 200 nm in thickness. In embodiments in which the passivation layer is electronically insulating, the reflective layer cannot function as a current collector.

The surface roughness can be defined as a measure of how smooth or flat the surface of a layer can be. It is typically measured as the differences between peaks and valleys on a given surface. For example, a common way in optics is to express the surface flatness with respect to the wavelength of light that is used. Typical mirrors show Lamda/10 (peak-to-valley) which, in this case, can be 80 nm.

In some embodiments, the surface roughness of the reflective layer may be less than 100 nm, 90, 80, 70, 60, 50, 40, 30, 20 or 10 nm peak to valley. In some embodiments, the surface roughness of the reflective layer may be less than 10 nm, 9 nm, 8 nm, 7 nm, 6 nm, 5 nm, 4 nm, 3 nm, 2 nm or 1 nm peak to valley.

In some embodiments, the surface roughness of the working electrode may be between 1 nm to 100 μm, or it may be 10 nm, 25 nm, 50 nm, 75 nm, 100 nm, 150 nm, 200 nm, 250 nm, 300 nm, 400 nm, 450 nm, 500 nm, 550 nm, 600 nm, 650 nm, 700 nm, 750 nm, 800 nm, 850 nm, 900 nm, 950 nm, 1 μm 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm or 95 μm peak to valley.

In some embodiments, the thickness of the reflective layer may be less than 200 nm, or it could be less than 190, 180, 170, 160, 150, 140, 130, 120, 110 or 100 nm. In some embodiments, the thickness of the reflective layer may be less than 100 nm, or it could be less than 90, 80, 70, 60, 50, 40, 30, 20 or 10 nm. In some embodiments, the thickness of the partially reflective layer can be between 10 to 200 nm, or it could be between 10 to 175 nm, 10 to 150 nm, 10 to 125 nm, 10 to 100 nm, 10 to 75 nm, 10 to 50 nm, 10 to 25 nm, 10 to 20 nm or 10 to 15 nm.

If the thickness of the reflective layer is too thin for example, less than 5 nm, then light can partially pass through the thin reflective layer.

It would be appreciated by the person skilled in the art that the maximum thickness of the reflective layer could be less than or equal to the surface roughness of the working electrode. The reflective layer must be thick enough to avoid being partially transparent and therefore reflect the majority of the reference beam. The threshold may vary from metal to metal but is typically between 10 nm to 100 nm thick.

In some embodiments, typical current collector foils that can be used in a battery, within the art, are often thicker than 15 μm and have a surface roughness greater than 500 nm peak to peak. Thick reflective layers with such a large variation are not suitable for use in the present invention.

The working electrode may be a free-standing working electrode or comprises a porous and/or a conductive material support. Advantageously, a working electrode can be self-supporting and therefore does not require additional layers. Beneficially, a porous and/or conductive material support provides structural rigidity, whilst enabling electrolyte and optical access to the working electrode.

The electrochemical cell may be a coin cell and/or mounted on a printed circuit board. Beneficially, the coin cell can be integrated into known systems for extensive performance testing, whilst also providing optical access to aid improvements in related battery technologies.

In a further aspect of the present invention, there is provided an electrochemical cell comprising: a working electrode comprising a channel passing at least partially therethrough; a transparent window configured to provide optical access to the working electrode; and a reflection interface between a portion of the transparent window and a portion of the channel, wherein the reflection interface is configured to change in a manner indicative of a corresponding change in the working electrode.

Advantageously, the electrochemical cell is optically accessible such that a portion of the working electrode comprising active material particles can be imaged in an improved manner during an electrochemical process.

The electrochemical cell may comprise a foil layer on a first surface of the working electrode. The transparent window may be configured to provide optical access to a second surface of the working electrode positioned opposite to the first surface. The electrochemical cell may comprise a foil layer on a first surface of the working electrode, wherein the transparent window is configured to provide optical access to the first surface of the working electrode through one or more apertures in the foil layer. Beneficially, the foil layer provides support for the working electrode without obscuring the portion of the working electrode layer that is imaged.

In some embodiments, the foil layer may be a current collector and/or a mesh layer. Advantageously the current collector provides electrical conductivity across the portion of the working electrode comprising the active material particles. Beneficially, the use of a mesh layer provides channels for electrolyte access to the active material particles of the working electrode.

In some embodiments, the channel may extend through the working electrode and the foil layer. Beneficially, the channel provides the means for electrolyte to access the active material particles whilst simultaneously providing an interface between the transparent window and channel that can provide a reflection interface for improved imaging of the working electrode during an electrochemical process.

In use, the channel may comprise an electrolyte. Advantageously, the electrolyte is provided within the portion of the working electrode comprising the active material particles whilst also providing a material with a different refractive index that can be used to form an interface usable for tracking changes at the surface of the working electrode.

In some embodiments, the working electrode may be in mechanical communication with the transparent window. Beneficially, physical changes in the working electrode, such as changes in the position due to swelling and contraction during electrochemical processes, cause physical changes in the position of the transparent window. Hence, the reflection interface formed between the channel through the working electrode and the transparent window can be monitored to provide improved imaging of the working electrode during operation of the electrochemical cell.

In some embodiments, the working electrode may comprise an active material wherein an active material loading of the working electrode may be at least 80%.

In another aspect of the present invention, there is also provided a method for imaging a working electrode through a transparent window during at least part of an electrochemical process, the method comprising: monitoring a reflection at a partially reflective layer in mechanical communication with the working electrode; imaging a portion of the working electrode during at least part of an electrochemical process with an imaging apparatus; determining a change in the reflection at the partially reflective layer; and adjusting the image focus of the imaging apparatus in response to determining the change, wherein monitoring the reflection comprises directing a reference beam at one of one or more regions of the partially reflective layer configured to reflect electromagnetic radiation and imaging the portion of the working electrode comprises imaging through one or more regions of the partially reflective layer configured to transmit electromagnetic radiation, wherein the working electrode is substantially in continuous contact with either the transparent window or the partially reflective layer.

In a further aspect of the present invention, there may be provided a method for imaging a working electrode during at least part of an electrochemical process, the method comprising: monitoring a reflection at a partially reflective layer in mechanical communication with the working electrode; imaging a portion of the working electrode during at least part of an electrochemical process with an imaging apparatus; determining a change in the reflection at the partially reflective layer; and adjusting the image focus of the imaging apparatus in response to determining the change, wherein monitoring the reflection comprises directing a reference beam at one of one or more regions of the partially reflective layer configured to reflect electromagnetic radiation and imaging the portion of the working electrode comprises imaging through one or more regions of the partially reflective layer configured to transmit electromagnetic radiation.

Advantageously, an improved system for stable imaging of working electrodes during their operation is provided.

In another aspect of the present invention, there may be provided a method for imaging a working electrode during at least part of an electrochemical process, the method comprising: monitoring a reflection at an interface between a transparent window and a channel that extends at least partially through the working electrode; imaging a portion of the working electrode during at least part of an electrochemical process with an imaging apparatus; determining a change in the reflection at the interface; and adjusting the image focus of the imaging apparatus in response to determining the change.

In use, the channel may comprise an electrolyte. Advantageously, the electrolyte is provided directly to the portion of the working electrode comprising the active material particles, whilst also functioning as part of a reflection interface that is usable as part of a feedback mechanism for stable imaging of a working electrode during its use.

In some embodiments, the step of imaging the portion of the working electrode may comprise imaging a first surface of the working electrode positioned opposite to a second surface of the working electrode, wherein the working electrode comprises a foil layer on the second surface. Advantageously, the foil provides support and uniform electrical conductivity without inhibiting optical inspection of the working electrode.

The step of imaging the portion of the working electrode may comprise imaging a first surface of the working electrode, wherein the working electrode comprises a foil layer comprising one or more apertures on the first surface. Advantageously, the foil provides support without inhibiting optical inspection of the working electrode.

In some embodiments, the step of monitoring the reflection may comprise directing a reference beam at the interface and detecting the position and/or intensity of the reflected reference beam. In some embodiments, monitoring the reflection may comprise detecting the position and/or intensity of the reflected reference beam. Beneficially, changes in the reflection of a reference beam indicate changes in the working electrode, thereby enabling adjustments to be made when imaging the working electrode.

In some embodiments, the step of adjusting the image focus may comprise dynamically altering the focal plane of the imaging apparatus, thereby compensating for changes in the position of the portion of the working electrode in a direction substantially perpendicular to the focal plane. Beneficially, improved stability in image focus is provided during electrochemical processes.

There is also provided a method of preparing an imaging system for imaging a working electrode during at least part of an electrochemical process in accordance with the method described herein.

The method of preparing an imaging system may comprise forming the partially reflective layer on the transparent window and subsequently bringing the transparent window with partially reflective layer substantially into continuous contact with the working electrode.

In some embodiments, the method of preparing an imaging system may comprise forming the partially reflective layer on the transparent window and subsequently bringing the transparent window with partially reflective layer into mechanical communication with the working electrode. Advantageously, the transparent window is used to provide a smooth surface for the partially reflective layer, enabling the formation of a thin layer in good mechanical communication with the working electrode.

In some embodiments, the method of preparing the imaging system may comprise the step of forming a channel at least partially through the working electrode. Advantageously, the provision of a channel enables electrolyte access to the active material particles of a working electrode whilst providing the means to form an interface to monitor reflections from a reference beam, wherein the reflections are indicative of changes in the working electrode that can be compensated for when imaging.

In some embodiments, the step of forming the channel may be implemented by forming the working electrode on a foil mesh or woven wire mesh comprising one or more channels. In some embodiments, alternatively, the channel is formed by perforating a foil layer and forming the working electrode on the perforated foil layer.

In some embodiments, alternatively, the channel is formed by forming the working electrode on a foil layer and subsequently perforating the working electrode. Beneficially, conventional working electrodes can be adapted for an optically accessible electrochemical cell, or commercially available meshes or adapted foils can be provided such that active material particles are subsequently cast upon them, providing channels with the benefits described herein.

In some embodiments, the step of perforating may comprise the use of at least one of: mechanical perforation; laser drilling; and laser ablation. Beneficially, mechanical perforation is an elegant and effective way to adapt existing materials. Advantageously, laser drilling and laser ablation provide fine control for creating uniform channels through working electrodes.

There may also be provided a system for imaging a working electrode during at least part of an electrochemical process, the system comprising: an imaging apparatus comprising a light source, wherein the system is configured to perform the method described herein.

The system may comprise an electrochemical cell in accordance with the electrochemical cells described herein.

The system may comprise an electrical connection for receiving an electrochemical cell, such as a battery.

In some embodiments, the system may comprise an electrical connection for receiving a battery electrode.

The light source may comprise, but is not limited to, at least one of the following: a laser; a light emitting diode; and a lamp, and/or wherein the imaging apparatus comprises an optical microscope.

Further aspects of the invention will be apparent from the description and the appended claims.

### BRIEF DESCRIPTION OF THE FIGURES

The invention will now be further and more particularly described, by way of example only, and with reference to the accompanying drawings, in which:

FIG. 1A shows a system for analysing the electrochemical performance of a dilute battery electrode by interferometric scattering, in accordance with the prior art;

FIG. 1B shows a cross-section of an electrochemical coin cell, in accordance with the prior art;

FIG. 2 shows a cross-section of an optically accessible electrochemical cell and optical imaging system;

FIG. 3 shows a process flow for imaging a working electrode during an electrochemical process;

FIG. 4 illustrates alternative embodiment of an optically accessible electrochemical cell and optical imaging system;

FIGS. 5 to 7 show cross-sectional views of alternative optically accessible electrochemical cells;

FIG. 8A shows an optical apparatus to enable autofocussing;

FIG. 8B shows monitored reflections from a reference beam;

FIG. 9 shows a cross-section of an optically accessible electrochemical cell and optical imaging system;

FIG. 10A shows an optical apparatus to enable autofocussing;

FIG. 10B shows monitored reflections from a reference beam;

FIGS. 11A and 11B show a sequence of cross-sectional images as part of a process for forming a working electrode;

FIGS. 12A and 12B show a sequence of cross-sectional images as part of a process for forming a working electrode; and

FIGS. 13A to 13C show a sequence of cross-sectional images as part of a process for forming a working electrode.

### DETAILED DESCRIPTION OF FIGURES

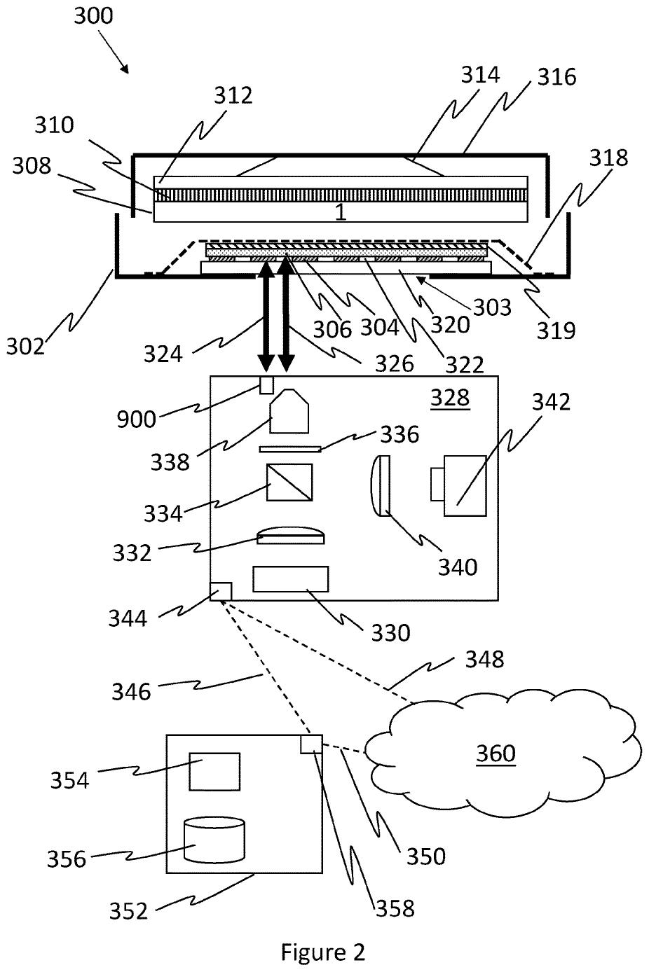

As described above, known methods for the optical imaging of electrochemical cell electrodes during real-time operation are not suitable for application to conventional electrochemical cell electrodes. FIG. 2 shows a cross-sectional view of an optically accessible electrochemical cell 300 forming part of a system for imaging a working electrode layer 306 of the electrochemical cell 300 during an electrochemical process. Advantageously, the arrangement described with reference to FIG. 2 enables the optical imaging of conventional electrochemical cell electrodes during real-time operation, thereby facilitating a greater understanding of the processes occurring during operation in such conventional electrodes, and hence issues that can be addressed in order to advance such technologies.

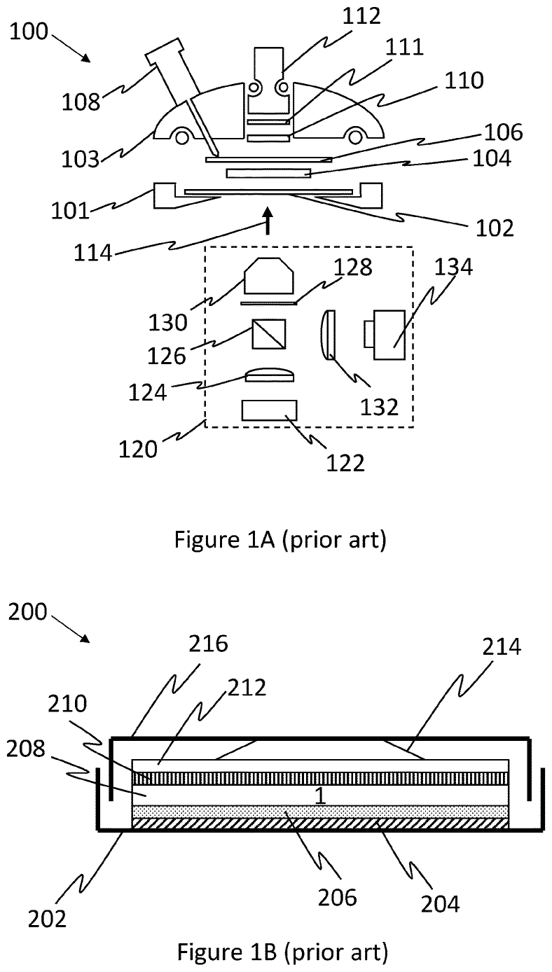

The electrochemical cell 300 comprises a cell casing 302, which in the orientation shown is the lower cell casing 302 (with the electrochemical cell 300 being orientable in any convenient direction in use). The lower cell casing 302 has an aperture 303 enabling optical access into the electrochemical cell 300, in contrast with the opaque, aperture-less, casing 202 of the prior art electrochemical coin cell 200 described with reference to FIG. 1B. There is a transparent window 320, which seals the aperture 303 whilst providing optical access into the interior of the electrochemical cell 300. The transparent window 320 is a glass coverslip affixed to the inside of the cell casing 302 using thermoplastic to create a seal. The thickness of the glass coverslip is approximately 170 microns and has a diameter of approximately 12 mm. The aperture 303 is circular with a diameter of 6 mm. In other, non-illustrated embodiments, the aperture 303 has a different shape and size whilst providing optical access to the interior of the electrochemical cell 300. In further non-illustrated embodiments, the transparent window 320 is formed from a different material, with the same or different thickness and/or diameter, to provide optical access to the working electrode of the electrochemical cell 300, such that the material is optically transparent at the wavelengths of light used to image the working electrode. In further non-illustrated embodiments, alternatively, the transparent window is affixed to the outside of the cell casing 302, or at least partially within the thickness of the cell casing 302. Whilst the transparent window 320 is described as being affixed to the cell casing 302 using a thermoplastic, in further examples, additional and/or alternative materials and/or techniques are used to affix the transparent window 320 to the cell casing 302.

Above the transparent window 320, there is shown a working electrode layer 306. The working electrode layer 306 is a conventional working electrode layer with a high density of active material particles cast upon a current collector layer 319. Together, the working electrode layer 306 comprising active material particles and the current collector layer 319 form a working electrode. The current collector layer 319 is an electrically conductive layer that is porous to liquid electrolyte material. In an example, the current collector layer 319 is a mesh layer, such as a metallic mesh layer. In further examples, the current collector layer 319 comprises Carbon paper. In further examples, the current collector layer 319 comprises any suitable material and structure that enables electrical conductivity between the working electrode layer 306 and the cell casing 302 and that is porous to liquid electrolyte in the electrochemical cell 300 such that liquid electrolyte reaches the working electrode layer 306.

In further examples, the current collector layer 319 is not included and the working electrode is formed only from the working electrode layer 306, which may be freestanding, or the working electrode is formed from the working electrode layer 306 in combination with one or more further layers, such as a foil layer.

A conductive mesh 318 is shown above the working electrode layer 306 and is in electrical communication with the lower cell casing 302. The conductive mesh 318 is an aluminium mesh, copper or stainless steel with open holes of different sizes, such as open holes of 1 mm diameter, and narrow ribbons of aluminium metal of 140 microns in width.

Whilst a conductive mesh 318 is shown in FIG. 2, in further non-illustrated examples, a conductive mesh 318 is not included. For example, the working electrode layer 306 may be in direct electrical contact with the cell casing 302. Alternatively and/or additionally, the transparent window 320 may be at least partially electrical conductive, thereby to provide electrical communication between the working electrode layer 306 and the cell casing 302.

In further non-illustrated examples, additional and/or alternative material can be used to provide electrical connection to the cell casing 302.

The working electrode layer 306 comprises active material particles. In an example, the active material comprises Lithium Cobalt Oxide (LCO). In further examples, the active material comprises Nickel-Manganese-Cobalt Oxide (NMC). In yet further examples, the working electrode layer 306 comprises any appropriate electrochemical cell material. In examples, additionally, the working electrode layer 306 comprises additional material, such as conductive additive material and/or binder material.

The working electrode layer 306 has a circular face with a diameter of 10 mm and is formed on the current collector layer 319, which is a circular aluminium mesh, copper or stainless steel with a thickness of 20 microns. In further examples, the working electrode is formed from a working electrode layer 306 and current collector layer 319 with different shapes and/or dimensions.

The partially reflective layer 304 is positioned on the side of the transparent window 320 opposite the working electrode layer 306 such that there are one or more reflective regions between the transparent window 320 and the working electrode layer 306 and one or more regions of the partially reflective layer 304 through which the working electrode layer 306 is optically accessible. The partially reflective layer 304 is a metallic layer that covers only part of the glass surface at the aperture 303, allowing the working electrode layer 306 to be imaged in the uncovered regions, which correspond to the one or more regions of the partially reflective layer 304 that are configured to transmit electromagnetic radiation. In an example, the reflective layer 304 is formed from at least one of gold, aluminium, platinum and copper. In further examples, the partially reflective layer 304 is formed from any material providing the functionality described herein.

In an example, the partially reflective layer 304 is formed by patterning a metallic layer on the transparent window 320. The metallic partially reflective layer 304 is patterned using sputtering or metallic deposition. The patterning of the partially reflective layer 304 is such that the layer has one or more reflective regions and one or more transparent regions, such that the working electrode 306 can be imaged through the transparent regions and the reflective regions provide an area in mechanical communication with the working electrode layer and from which a reference reflection beam can be monitored. The patterning can take any appropriate configuration and is implemented by any appropriate means, such as by physical masking and/or photolithography, for example. The partially reflective layer 304 may be continuous or discontinuous, providing one or more substantially optically reflective regions and one or more substantially optically transparent regions. In an example, the substantially optically transparent regions correspond to the absence of a reflective material deposited in those regions. The planar area and shape of the partially reflective layer 304 may be the same as, or different from, the planar area and shape of the working electrode layer 306. For example, the partially reflective layer 304 may comprise a reflective region positioned to cover any appropriate area of the working electrode layer 306 whilst enabling optical access to any appropriate area of the working electrode layer 306. Whilst the partially reflective layer 304 is a patterned layer, in further examples the partially reflective layer 304 is alternatively or additionally formed using one or more preformed substantially optically reflective and/or transparent features. Accordingly, the optically reflective features are fiducial markers enabling the autofocussing functionality described herein.

In an example, a transparent window 320 formed of glass is coated with a 50 nm thick layer of platinum, providing a smooth surface with high reflectivity (50 nm of platinum providing >90% reflectance). In further examples, the metallic partially reflective layer 304 is formed from any appropriate material with appropriate thickness to provide the functionality described herein.

In further examples, the metallic partially reflective layer 304 is provided by painting or marking the transparent window 320 surface using conductive paint, such as Ag paint, or by using metallic marker pen. In further examples, the metallic partially reflective layer 304 is provided by any suitable technique.

The interface between the partially reflective layer 304 and the transparent window 320 provides a clean and flat interface that aids active focus stabilisation. The interface, which in an example is a metal-glass interface, is smooth and unchanging, in contrast to the relatively rough and inconsistent working electrode layer 306 surface.

The working electrode layer 306 with active material particles is positioned such that active material particles are viewable at one or more regions 322 through the transparent window 320. The one or more regions 322 through which the active material particles are viewable may be associated with a separation between the working electrode layer 306 and the transparent window 320, as shown at FIG. 2. In further examples, the volume associated with the lateral gap between regions of the partially reflective layer 304 and a vertical separation between the working electrode layer 306 and the transparent window 320 is at least partially filled with one or more materials, which may include portions of the working electrode layer 306, for example. The working electrode layer 306 comprising active material particles is pressed against the internal face of the transparent window 320 patterned with the partially reflective layer 304 such that the working electrode layer 306 and the transparent window 320 are in mechanical communication. In further examples, there are one or more further layers between the working electrode layer 306 and the transparent window 320 such that the functionality described herein is maintained.

Whilst the partially reflective layer 304 is formed on the transparent window 320 prior to being brought into mechanical communication with the working electrode layer 306, in further examples, the partially reflective layer 304 is alternatively formed on the working electrode layer 306 prior to being brought into mechanical communication with the transparent window 320. When the partially reflective layer 304 is formed on the working electrode layer 306, it is in mechanical communication with the working electrode layer 306. In yet further examples, the partially reflective layer 304 is provided by introducing a separate layer between the transparent window 320 and the working electrode layer 306. For example, a metallic mesh layer placed between the working electrode layer 306 and the transparent window 320 provides a smooth reflective surface for a reference reflection, whilst enabling optical access to the working electrode layer 306 during operation.

The partially reflective layer 304 is shown with a plurality of regions 322 that enable optical inspection of the working electrode layer 306 through the transparent window 320.

The partially reflective layer 304 formed on the transparent window 320 provides a clean and flat surface that can be used as a reference reflection interface for image focus stabilisation, as described herein. As the working electrode layer 306 is mechanically coupled to the transparent window 320, changes in the position of the partially reflective layer 304 formed on the transparent window 320 enable the corresponding changes in the surface of the working electrode layer 306 in the vicinity of the partially reflective layer 304 to be tracked, thereby providing an input for the imaging focus of the working electrode layer 306 to be adjusted in the event of any changes in the position of the working electrode layer 306 (e.g., due to swelling/contraction during operation of the electrochemical cell 300). Such a change is indicative of behaviour in the working electrode layer 306 and may be used to inform an adjustment of an image focus of a portion of the working electrode layer 306 during an electrochemical process.

Above the conductive mesh layer 318 there is shown in FIG. 2 a separator 308, a counter electrode 310, a spacer 312 and a spring 314, corresponding to the separator 208, counter electrode 210, spacer 212 and spring 214 described with respect to the conventional electrochemical coin cell 200 of the prior art shown in FIGS. 1A and 1B. The separator 308 is a glass fibre separator and the spacer 312 is a stainless steel spacer. In further non-illustrated examples, additional and/or alternative layers and/or components are implemented.

The stack of layers within the electrochemical cell 300 is wetted with an electrolyte. In an example, 200 μl of LP57 electrolyte is used. In further examples, a different amount and/or type of electrolyte is used, including, for example, solid state electrolytes (SSEs). The layers within the electrochemical cell 300 are encased with the upper cell casing 316, thereby sealing the electrolyte within the electrochemical cell 300. The working electrode layer 306 is optically accessible through the transparent window 320 created within the aperture 303 in the lower cell casing 302.

Whilst the electrochemical cell 300 is described with respect to particular layers formed in a particular order, in further examples, additional, fewer and/or alternative layers and/or components are used to provide an optically accessible electrochemical cell in accordance with the claimed invention. For example, in further examples, the working electrode is a free-standing electrode layer that does not include a current collector layer 319. In further examples, the working electrode comprises a foil layer on the surface of the working electrode layer 306 positioned between the transparent window 320 and the working electrode layer 306. In such a configuration, the foil layer comprises one or more apertures, which expose corresponding portions of the working electrode layer 306, thereby to enable optical access to the working electrode layer 306 through the foil layer, such that the working electrode layer 306 is imaged in accordance with the methods described herein. In such cases, the foil layer may also be the partially reflective layer 304.

The cell casing 302, 316 forms a coin cell casing, such as a modified CR2032 coin cell casing. In further examples, the electrochemical cell 300 has the form of a different coin cell. In further examples, the electrochemical cell 300 is a different type of cell, such as a pouch cell or a Swagelok® type cell, and the internal components are arranged analogously whilst providing the benefits described herein.

Electrical connections made to the upper cell casing 316 and the lower cell casing 302 facilitate the application of current-voltage conditions, such as charging and discharging conditions, which cause electrochemical processes to occur within the electrochemical cell 300. Such electrochemical processes can be imaged by imaging a portion of the working electrode layer 306 that is optically accessible through the transparent window 320.

Advantageously, the arrangement of the entities in the electrochemical cell 300 is such that electrolyte can access the active material of the working electrode layer 306, whilst facilitating improved imaging, as described herein. Further, the electrochemical cell 300 is relatively cost effective, easy to assemble, can be integrated into route battery testing and provide much improved cycling performance compared with known cells.

The working electrode layer 306 is imaged using an imaging apparatus 328. The imaging apparatus 328 comprises a light source 330 providing light for illuminating/imaging in a direction, as indicated by an arrow 326. The light source is a 530 nm light emitting diode (LED). In further examples, alternative and/or additional light sources, such as laser diodes, lamps and/or LEDs with different peak wavelengths are used for illumination/imaging of the working electrode layer 306.

In order to image the working electrode layer 306, the electrochemical cell 300 is held in place in an appropriate location, such as a part of a sample stage. In an example, the imaging apparatus 328 comprises a fixed location for receiving the electrochemical cell 300 and for making electrical connections to the electrodes of the electrochemical cell 300, such that appropriate current-voltage conditions can be applied whilst imaging the working electrode layer 306.

The light source 330 is arranged in order to direct light through an optical microscope comprising a lens system 332, polarising beam splitter 334 or beam splitter, quarter wave plate 336 and objective 338, to a visually exposed portion of the working electrode 306, such that the portion of the working electrode 306 is imaged. Light scattered by the portion of the working electrode layer 306 is then directed through the objective 338, quarter wave plate 336 and by the beam splitter 334, through the lens system 340 to the camera 342, where images of the portion of the working electrode layer 306 are captured.

Whilst the optical microscope comprises a particular arrangement for imaging the working electrode layer 306, in further examples, alternative and/or additional optical components are implemented in order to provide imaging focussed on a portion of the working electrode layer 306 during an electrochemical process.

The imaging apparatus 328 is in communication with a computing device 352 via a communication path 346 between an interface 344 of the imaging apparatus 328 and an interface 358 of the computing device 352. The computing device 352 comprises a processor 354 and a memory 356. The computing device 352 is in communication with a network 360 via a communication path 350 between the computing device 352 and the network 360. The imaging apparatus 328 is also in communication with the network 360 via a communication path 348 and the interface 344 of the imaging apparatus 328.

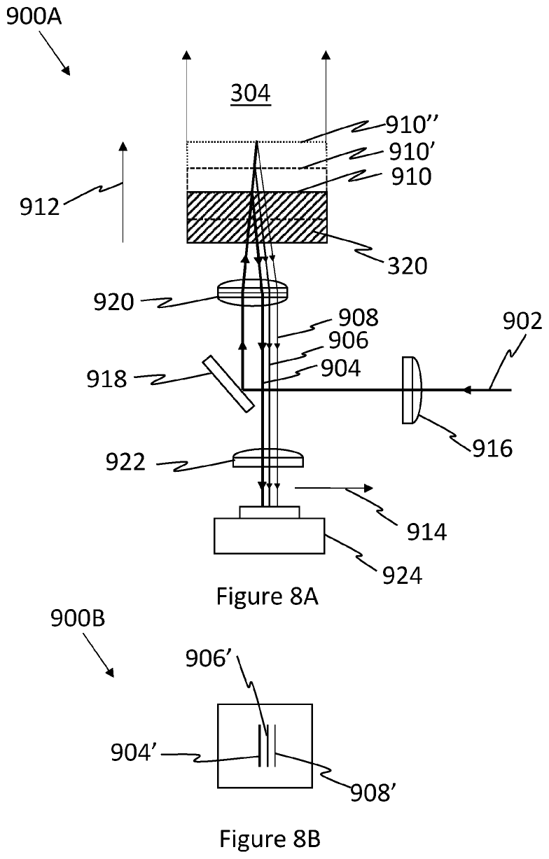

The computing device 352 is in communication with an autofocussing apparatus 900, which is described in further detail with reference to FIG. 8. The autofocussing apparatus 900 is used to direct and measure a reflection of a reference beam 324 from a partially reflective layer 304 formed in the optically accessible electrochemical cell 300.

Whilst the imaging apparatus 328 and autofocussing apparatus 900 are shown in communication with a computing device 352 and a network 360, in further non-illustrated embodiments, the imaging apparatus 328 and autofocussing apparatus 900 are implemented and controlled in any suitable manner in accordance with the techniques described herein. In an example, the computing device 352 is integrated into the imaging apparatus 328 and/or autofocussing apparatus 900.

During imaging of a portion of the working electrode layer 306, it is important to maintain the focus of the surface of the portion of the working electrode layer 306 that is being imaged. The computing device 352 is configured to communicate with the imaging apparatus 328 and autofocussing apparatus 900 such that the optical components of the imaging apparatus 328 and/or the relative position of the imaging apparatus 328 with respect to the electrochemical cell 300 are dynamically controlled.

In order to maintain the focus of the surface of the portion of the working electrode layer 306 that is being imaged, the focal plane of the optical apparatus is adjusted in a direction substantially perpendicular to the surface of the portion of the working electrode layer 306 (which may be substantially perpendicular to the planar surface of the working electrode layer 306 adjacent to the transparent window 320). In Cartesian coordinates, where the planar surface of the working electrode layer 306 lies in a plane substantially defined by the x-axis and the y-axis, the focal plane of the optical apparatus is adjusted along the z-axis in order to provide a focussed image of a portion of the working electrode layer 306.

Whilst a portion of the working electrode layer 306 initially may be brought into focus by changing the relative position of the focal plane in a direction perpendicular to the z-axis such that the portion coincides with the focal plane of the optical apparatus 328, during real-time operation of the electrochemical cell 300 by the application of current-voltage conditions, the position of the portion of the working electrode layer 306 may change, such that it no longer coincides with the focal plane. Such changes can result from the working electrode layer 306 swelling or contracting during operation, changes in the refractive index of electrolyte within the electrochemical cell 300 during operation, and changes due to drift in the sample stage supporting the electrochemical cell during operation.

As described above, the high density of active material in conventional electrochemical cell electrodes means that the surface is rough and not suitable for using as a reference point for maintain focus stabilisation, as with dilute electrochemical cell electrodes, where a reference light beam with a suitable spot size is positioned on the relatively smooth and inactive surface between active particles such that changes in the z-position of the dilute electrode can be tracked. Advantageously, the partially reflective layer 304 patterned on the transparent window 320 benefits from the smooth window surface, which is typically glass, such that a very thin partially reflective layer 304 is formed next to the working electrode layer 306, enabling good mechanical communication between the transparent window 320 and the working electrode layer 306. Additionally, the reflective regions of the thin partially reflective layer 304 provide reference points for a reference reflection that can be used to monitor changes in the working electrode layer 306 that result in changes with respect to the relative difference in position between the portion of the working electrode layer 306 that is being imaged and the focal plane of the optical apparatus 328 that is being used to image the portion of the working electrode layer 306.

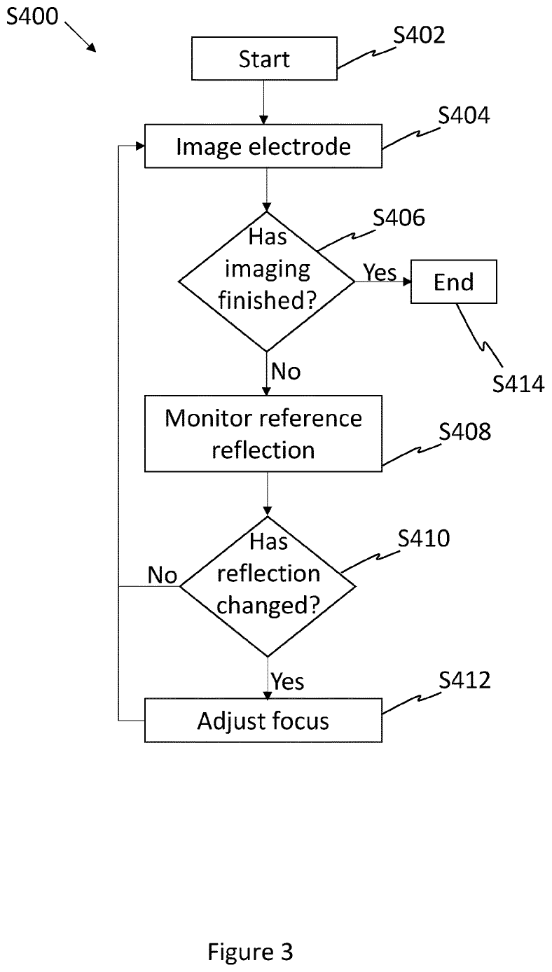

FIG. 3 shows a process flow S400 for imaging a portion of the working electrode layer 306 of the optically accessible electrochemical cell 300 during an electrochemical process. The process flow S400 is performed using the imaging apparatus 328 described with reference to FIG. 2 and/or in other embodiments referenced in the description that provide similar or identical functionality, in order to image a portion of the working electrode layer 306 of the optically accessible electrochemical cell 300. The process flow S400 is controlled using a computing device 352 described with reference to FIG. 2. The computing device 352 is used to control the imaging process directly through control of the imaging apparatus 328 and/or indirectly via a computing network 360.

The process is initiated at a first step S402 and moves to step S404, where a portion of the working electrode layer 306 is imaged. The process may be initiated by a user identifying a portion of the working electrode layer 306 to image and initiating an experiment to perform an electrochemical process at the electrochemical cell 300 whilst simultaneously imaging a portion of the working electrode layer 306 and automatically maintaining focus of the portion of the working electrode layer 306 that is to be imaged.

In order to image a portion of the working electrode layer 306, the imaging apparatus 328 is arranged such that the portion of the working electrode layer 306 is illuminated with light, as shown by the arrow 326 in FIG. 2. The working electrode layer 306 is imaged through a transparent region of the partially reflective layer 304. The image focus of the imaging apparatus 328 is adjusted such that the focal plane of the imaging apparatus 328 coincides with the portion of the working electrode layer 306 that is being imaged. An electrochemical process is initiated by applying the appropriate current-voltage conditions to the electrodes 306, 310 of the electrochemical cell 300.

An example of an electrochemical process is charging and discharging the electrochemical cell 300 using CC CV-CC CV cycling protocols at a constant-current (CC) rate of C/5 (nominal 5 hour (dis)charging time) with a constant voltage (CV) of 1 hour. In further examples, different electrochemical processes are instigated.

The process then moves to step S406, where it is determined whether the imaging is complete. The decision to determine whether the imaging is complete or not is optionally based on user intervention, or alternatively and/or additionally, by control of the imaging apparatus 328 based on computer implemented instructions executed by the computing device 352, for example, based on computer implemented instructions stored in the memory 356 of the computing device 352.

If the imaging has not finished, the process moves to step S408, where a reference reflection is monitored. The reference reflection is monitored by the computing device 352 in combination with the imaging apparatus 328. The computing device 352 is integrated into the imaging apparatus 328 in an example. The computing device 352 is configured to implement a hardware or software feedback protocol, for instance a proportional integral derivative (PID) control system such that inputs based on the monitored reflection of a reference beam are processed by the processor 354 in order to determine focussing control of the imaging apparatus 328. Imaging and focus adjustment can occur in series or in parallel. For example, the imaging apparatus 328 can continue to take images of the portion of the working electrode layer 306 whilst the autofocussing apparatus 900 simultaneously monitors the reference reflection, such that the computing device 352 coordinates the imaging and focus adjustment in any suitable manner.

The reference reflection is monitored by directing focussed radiation at a reflective region of the partially reflective layer 304 formed on the transparent window 320. Advantageously, the partially reflective layer 304 provides the means for obtaining a clean and consistent reflection that is inextricably linked to the working electrode layer 306 such that a change in a reflection at the partially reflective layer 304 is indicative of a change in the working electrode layer 306. This means, for example, that if the working electrode layer 306 changes during operation such that the portion being imaged moves out of the focal plane of the imaging apparatus 328, the change in reflection at the reflection interface is used as an input to compensate for the change by adjusting the focal plane of the imaging apparatus 328 in the z-direction substantially perpendicular to the planar surface of the portion of the working electrode layer 306 that is being imaged, thereby maintaining a stable focus.

The reference reflection is monitored using the optical apparatus 900 described with reference to FIGS. 8A and 8B, in combination with the computing device 352 and/or imaging apparatus 328.

FIG. 8A shows an optical apparatus 900A to enable autofocussing of the imaging apparatus 328, as controlled by the computing device 352, thereby to illustrate the principle of using a reference beam reflected at a reflection interface, such as between the transparent window 320 and the partially reflective layer 304, to determine changes in reflections and to compensate for them accordingly.

There is shown a reference beam 902 from a light source that is directed through a focusing lens 916 and via a mirror 918 through an objective 920 such that it is focussed at a reflection interface between the transparent window 320 and the partially reflective layer 304. The light source is a collimated low power laser beam with a wavelength of 785 nm. In further examples, any suitable wavelength, power and/or type of light source is used to provide a reference beam.

As illustrated with the arrow 324 in FIG. 2, the reference beam is directed at an interface between the transparent window 320 and the partially reflective layer 304. Advantageously, the partially reflective layer 304 is a thin layer, thereby simultaneously providing excellent mechanical communication with the working electrode layer 306 whilst also providing a reference point to determine any changes that may alter the image focus of the working electrode layer 306.

In the example of FIG. 8A, there is shown the transparent window 320 such that there is a reflection interface between the transparent window 320 and the partially reflective layer 304 is at a first position 910. The reference beam 902 is focussed at the interface between the transparent window 320 in the first position 910 and the region of the partially reflective layer 304. The reference beam 902 is focussed such that it provides a focus spot at the reflection interface with a Gaussian full width half maximum of 5 to 15 microns. In further examples, a different spot size is used in order to monitor a change at the reflection interface.

A first reflected beam 904 from the reflection interface between the transparent window 320 in the first position 910 and the partially reflective layer 304 is directed through the objective 920 and a cylindrical lens 922 to a camera 924, where the first reflected beam 904 provides a reflection line at a first position 904′, as shown in the projection 900B of the x-y plane of a reference beam image captured by the camera 924 at FIG. 8B.

When the transparent window 320 moves in the z-direction 912 such that the reflection interface between the transparent window 320 and the partially reflective layer 304 is at a second position 910′, there is a corresponding change in the reflection of the reference beam 902 such that a second reflected beam 906 from the reflection interface formed by the transparent window 320 and the partially reflective layer 304 in the second position 910′ provides a reflection line at a second position 906′, as shown in the projection 900B of a reference beam image captured by the camera 924 at FIG. 8B.

The z-direction 912 corresponds to a direction substantially perpendicular to the planar surface of the working electrode layer 306. Such a change in position of the working electrode layer 306 occurs, for example, due to electrode swelling or contraction under operating conditions.

When the reflection interface between the transparent window 320 and the partially reflective layer 304 moves from the second position 910′ to a third position 910″, there is a corresponding change in the reflection of the reference beam 902 such that a third reflected beam 908 from the reflection interface formed by the transparent window 320 and the partially reflective layer 304 in the third position 910″ provides a reflection line at a third position 908′, as shown in the projection 900B of a reference beam image captured by the camera 924 at FIG. 8B.

As shown at FIG. 8A the lateral position of the reflected beams 904, 906, 908 changes in a lateral direction 914 in the x-y plane, perpendicular to the movement of the interface between the transparent window 320 and the partially reflective layer 304 in the z-direction, as a function of the position of the reflection interface between the transparent window 320 and the reflective layer 304. Accordingly, by monitoring the reflection of the reference beam, changes in the reflection at the reflection interface can be determined and corresponding changes in the working electrode layer 306 can be taken into account.

Whilst the arrangement of the autofocussing optical apparatus 900A, 900B described with reference to FIGS. 8A and 8B is such that the monitored reflections manifest as lines at the camera 924, in further examples, additional and/or alternative detections of monitored reflections are used to determine changes in the position of the interface between the transparent window 320 and the reflective layer 304, for example based on changes in position and intensity of detected monitored reflections.

Whilst a particular arrangement of optical components for monitoring a reference beam reflection is described with respect to FIGS. 8A and 8B, in further examples additional and/or alternative optical components are used in order to provide the functionality described herein.

The process then moves to step S410, where it is determined if the reference reflection at the interface between the transparent window 320 and the partially reflective layer 304 has changed. If the reference reflection has not changed, the process moves to step S404 the portion of the working electrode layer 306 is imaged again by the imaging apparatus 328. If it is determined at step S406 that the imaging has finished, the process ends at step S414.

If it is determined at step S410 that the reference reflection has changed, the process moves to step S412, where the image focus of the portion of the working electrode is adjusted, thereby to compensate for changes during the electrochemical process. As the change in the reflection of the reference beam at the reflection interface between the transparent window 320 and the partially reflective layer 304 varies as a function of a corresponding change in the working electrode layer 306, the focal plane of the imaging apparatus 328 is adjusted based on the change in the reflection at the reflection interface, in order to compensate for differences between the position of the focal plane and the portion of the working electrode layer 306 that is being imaged.

The imaging and monitoring steps of the process flow S400 are repeated for the desired duration of the operation of the electrochemical cell 300 that is being investigated. Whilst particular steps are shown in the process flow S400, the skilled person understands that in further non-illustrated embodiments, additional and/or alternative steps are implemented, whilst providing the functionality described herein. In further embodiments, the steps of process flow S400 are performed in any manner, simultaneously or sequentially, in order to provide the functionality of adjusting the imaging of a working electrode in response to determining a change in a reference beam reflected at a reflection reference interface described herein.

Advantageously, the arrangement of the electrochemical cell 300 described with reference to FIG. 2 is such that a portion of the working electrode can be monitored in real time in an improved manner. The rate at which imaging and adjusting image focus occurs is configurable in order to determine desired data.

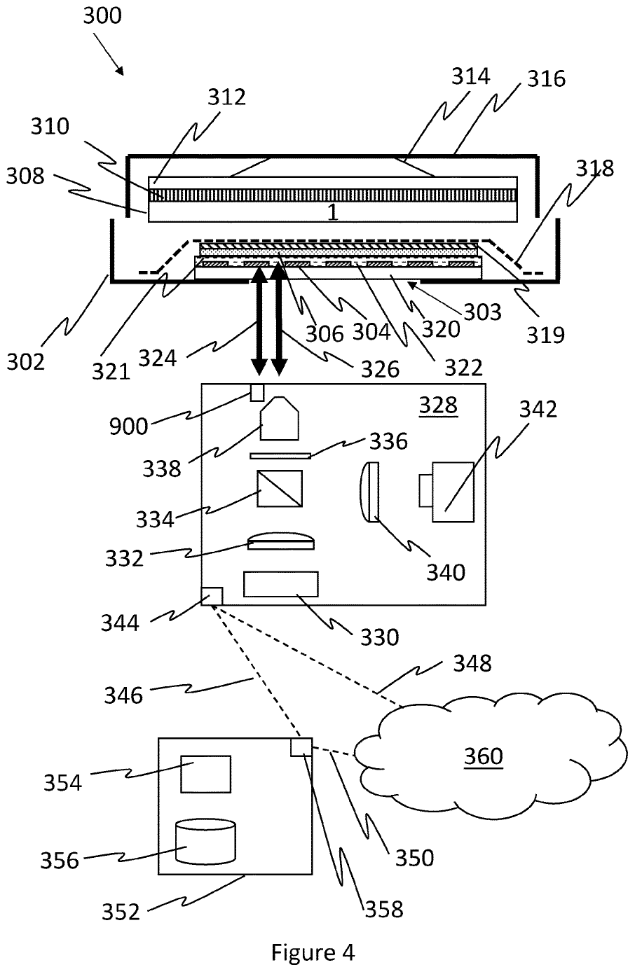

FIG. 4 shows an alternative embodiment of an optically accessible electrochemical cell and imaging system to FIG. 2. FIG. 4 shows a cross-sectional view of an optically accessible electrochemical cell 300 forming part of a system for imaging a working electrode layer 306 of the electrochemical cell 300 during an electrochemical process.

In this embodiment as illustrated in FIG. 4, the transparent window 320 comprises a passivation layer 321. The passivation layer 321 is provided in the part of the transparent window 320 that is adjacent to the partially reflective layer 304 and/or the working electrode 306 and thereby provides the substantially continuous contact therewith. The incorporation of a passivation layer 321 into the transparent window 320 prevents chemical and/or electrochemical changes occurring in the partially reflective layer 304, by preventing electronic and/or ionic contact to the partially reflective layer 304. The passivation layer 321 is optically transparent and is also electronically insulating. The passivation layer 321 may be made from an oxide, including but not limited to, silicon dioxide, aluminium oxide, hafnium dioxide, or titanium dioxide. The passivation layer may be a polymer, including but not limited to, poly(methyl methacrylate) (PMMA). The passivation layer may be less than 200 nm in thickness.

As shown schematically in FIG. 4, the imaging apparatus 328 is in communication with a computing device 352 via a communication path 346 between an interface 344 of the imaging apparatus 328 and an interface 358 of the computing device 352. The computing device 352 comprises a processor 354 and a memory 356. The computing device 352 is in communication with a network 360 via a communication path 350 between the computing device 352 and the network 360. The imaging apparatus 328 is also in communication with the network 360 via a communication path 348 and the interface 344 of the imaging apparatus 328.

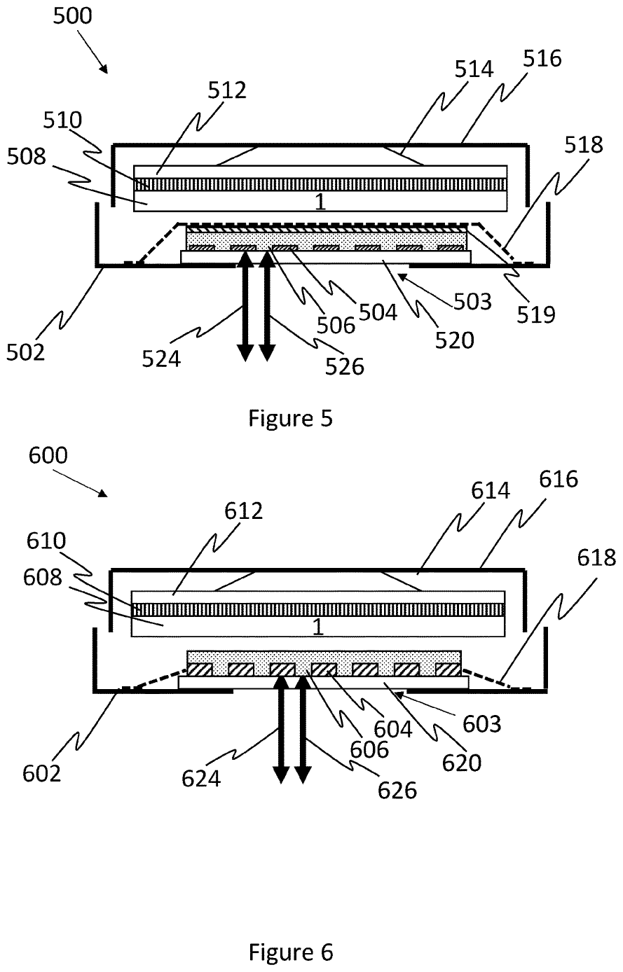

Whilst the example of the arrangement of the electrochemical cell 300 shown at FIG. 2 has numerous benefits relating to improved imaging of a working electrode layer 306 during an electrochemical process due to the excellent mechanical communication between a reference interface between the partially reflective layer 304 and the working electrode layer 306 adjacent to regions 322 associated with optical access through the transparent window 320 to the working electrode layer 306, analogous functionality may be implemented through the formation of reflection interfaces in alternative ways, as shown with reference to the examples of FIGS. 5 to 7. The electrochemical cells 500, 600, 700, 800 described with reference to FIGS. 5 to 7 are used in the implementation of the process S400 described with reference to FIG. 3. In further examples, the electrochemical cells 500, 600, 700, 800 and their alternative configurations, are implementable in accordance with any methodology that provides the functionality described herein.

FIG. 5 shows a cross-sectional view of an electrochemical cell 500. In the example of FIG. 5, the electrochemical cell 500 has components that are equivalent to those shown in respect of the electrochemical cell 300 shown at FIG. 2. For example, the electrochemical cell 500 comprises a cell casing 502, which in the orientation shown is the lower cell casing 502 (with the electrochemical cell 500 being orientable in any convenient direction in use). The lower cell casing 502 has an aperture 503 enabling optical access into the electrochemical cell 500, in contrast with the opaque, aperture-less, casing 202 of the prior art electrochemical coin cell 200 described with reference to FIG. 1B. There is a transparent window 520, which seals the aperture 503 whilst providing optical access into the interior of the electrochemical cell 500, in the manner described with reference to the transparent window 320 of FIG. 2. Above the transparent window 520, there is shown a working electrode comprising a working electrode layer 506 and a current collector layer 519. A conductive mesh 518 is shown above the working electrode and is in electrical communication with the lower cell casing 502. Above the conductive mesh layer 518 there is shown in FIG. 5 a separator 508, a counter electrode 510, a spacer 512 and a spring 514, corresponding to the separator 308, counter electrode 310, spacer 312 and spring 314 described with respect to the electrochemical coin cell 300 of FIG. 2.

In contrast to the electrochemical cell 300 shown at FIG. 2, the electrochemical cell 500 of FIG. 5 shows a partially reflective layer 504 that is embedded in the working electrode layer 506. The partially reflective layer 504 comprises one or more regions configured to reflect electromagnetic radiation and one or more regions configured to transmit electromagnetic radiation. The planar area and shape of the partially reflective layer 504 may be the same as, or different from, the planar area and shape of the working electrode layer 506.

Advantageously, the partially reflective layer 504 is at least partially embedded in the material of the working electrode layer 506 and the material of the working electrode layer 506 is at least partially formed in the areas between patterned portions of the partially reflective layer 504, such that the working electrode layer 506 can be in direct mechanical contact with the transparent window 520. Accordingly, the one or more regions of the partially reflective layer 504 that are configured to transmit electromagnetic radiation coincide with the portions of the working electrode layer 506 that are to be imaged. Beneficially, when the partially reflective layer 504 is at least partially embedded in the material of the working electrode layer 506 such that it extends beneath the surface of the working electrode layer 506 in a direction substantially perpendicular to the planar face of the working electrode layer 506 that is to be imaged, the distance between the surface of the partially reflective layer 504 and the surface of the working electrode layer 506 can be reduced. Further, formation of the working electrode layer 506 in the areas between substantially reflective areas of the partially reflective layer 504 provides areas that are relatively flat with respect to the surface of the partially reflective layer 504, thus providing large surface areas that can be imaged with dynamic autofocussing.

In further examples, alternatively or additionally, the partially reflective layer 504 comprises one or more fiducial markers to form one or more of the regions configured to reflect electromagnetic radiation, wherein the one or more fiducial markers are at least partially embedded in the surface of the working electrode layer 506.

FIG. 6 shows a cross-sectional view of an electrochemical cell 600. In the example of FIG. 6, the electrochemical cell 600 has components that are equivalent to those shown in respect of the electrochemical cell 300 shown at FIG. 2. For example, the electrochemical cell 600 comprises a cell casing 602, which in the orientation shown is the lower cell casing 602 (with the electrochemical cell 600 being orientable in any convenient direction in use). The lower cell casing 602 has an aperture 603 enabling optical access into the electrochemical cell 600, in contrast with the opaque, aperture-less, casing 202 of the prior art electrochemical coin cell 200 described with reference to FIG. 1B. There is a transparent window 620, which seals the aperture 603 whilst providing optical access into the interior of the electrochemical cell 600, in the manner described with reference to the transparent window 320 of FIG. 2. Above the transparent window 620, there is shown a working electrode layer 606. Above the working electrode layer 606 there is shown in FIG. 6 a separator 608, a counter electrode 610, a spacer 612 and a spring 614, corresponding to the separator 308, counter electrode 310, spacer 312 and spring 314 described with respect to the electrochemical coin cell 300 of FIG. 2.

In contrast to the electrochemical cell 300 shown at FIG. 2, the electrochemical cell 600 of FIG. 6 shows a metallic foil layer 604 that is a partially reflective layer 604, upon which the working electrode layer 606 is formed, e.g., by casting the working electrode layer 606 on the metallic foil layer 604. The metallic foil layer 604 extends to the cell casing 602 and is in electrical communication with the cell casing 602 through a portion 618 of the metallic foil layer 604. In further examples, the metallic foil layer 604 is not in direct electrical contact with the cell casing 602 and electrical conductivity between the working electrode layer 606 and the cell casing 602 is provided by one or more separate electrically conductive entities between the cell casing 602 and the working electrode layer 606. The planar area and shape of the partially reflective layer 604 may be the same as, or different from, the planar area and shape of the working electrode layer 606.

Advantageously, the metallic foil is a partially reflective layer 604 and is a solid layer upon which the working electrode layer 606 can be cast. Simultaneously, the metallic foil layer 604 provides one or more apertures for imaging the working electrode and a smooth face usable for a good reference reflection for autofocus, whilst also being electrically conductive. Accordingly, the partially reflective layer 604 comprises one or more regions configured to reflect electromagnetic radiation and one or more regions configured to transmit electromagnetic radiation.

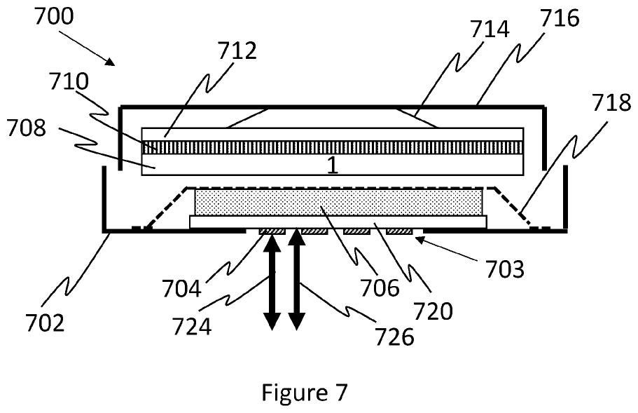

FIG. 7 shows a cross-sectional view of an electrochemical cell 700. In the example of FIG. 7, the electrochemical cell 700 has components that are equivalent to those shown in respect of the electrochemical cell 300 shown at FIG. 2. For example, the electrochemical cell 700 comprises a cell casing 702, which in the orientation shown is the lower cell casing 702 (with the electrochemical cell 700 being orientable in any convenient direction in use). The lower cell casing 702 has an aperture 703 enabling optical access into the electrochemical cell 700, in contrast with the opaque, aperture-less, casing 202 of the prior art electrochemical coin cell 200 described with reference to FIG. 1B. There is a transparent window 720, which seals the aperture 703 whilst providing optical access into the interior of the electrochemical cell 700, in the manner described with reference to the transparent window 320 of FIG. 2. Above the transparent window 720, there is shown a working electrode layer 706. In the example of FIG. 7, the working electrode layer 706 is a freestanding electrode. In further examples, the working electrode layer 706 comprises one or more additional supportive layers, upon which the working electrode layer 706 is cast. A conductive mesh 718 is shown above the working electrode layer 706 and is in electrical communication with the lower cell casing 702. Above the conductive mesh layer 718 there is shown in FIG. 7 a separator 708, a counter electrode 710, a spacer 712 and a spring 714, corresponding to the separator 308, counter electrode 310, spacer 312 and spring 314 described with respect to the electrochemical coin cell 300 of FIG. 2.

In contrast to the electrochemical cell 300 shown at FIG. 2, the electrochemical cell 700 of FIG. 7 shows a partially reflective layer 704 formed on the opposite, outside, face of the transparent window and the working electrode layer 706, in close mechanical contact with the transparent window 720. The partially reflective layer 704 comprises one or more regions configured to reflect electromagnetic radiation and one or more regions configured to transmit electromagnetic radiation. The planar area and shape of the partially reflective layer 704 may be the same as, or different from, the planar area and shape of the working electrode layer 706.

Advantageously, the positioning of the partially reflective layer 704 on the transparent window 704 means that the smooth surface of the transparent window 704 is pressed up against the working electrode layer 704, thereby providing excellent mechanical communication between the transparent window 720 and the working electrode layer 704, such that changes at the interface between the partially reflective layer 704 and material outside the electrochemical cell 700 (e.g., air, nitrogen, vacuum etc.) represent changes in the working electrode layer 700. Further, a partially reflective layer 704 on the outside of the electrochemical cell 700 can be replaced, as needed, without disturbing the rest of the electrochemical cell 700. This could enable, for example, a change in pattern of the partially reflective layer 704 in order to image different parts of the working electrode layer 706.

Advantageously, the position of the partially reflective layer 704 on the external surface of transparent window 704 also means that the electrochemical cell 700 can be assembled before the partially reflective layer 704 is formed. Therefore, the decision as to where the reflective regions of the partially reflective layer 704 are formed can be made based on knowledge of the viewable area of the working electrode layer 706 through the aperture 703 in the cell casing 702.

Further, beneficially, the position of the partially reflective layer 704 on the external surface of the transparent window 704 can be used for imaging with the use of an oil objective as part of the imaging apparatus 328 to provide improved imaging resolution.

The partially reflective layer 704 comprises a metal. Beneficially, metallic layers can provide high reflectivity and accurate control of reflective regions. In further examples, alternatively or additionally, the partially reflective layer 704 comprises an electrochemically active material with high reflectivity characteristics. Beneficially, materials that could not otherwise be used inside the electrochemical cell 700 can be used to provide reflective regions for a reference reflection.

Whilst the electrochemical cells 500, 600, 700 described with reference to FIGS. 5 to 7 are shown with particular configurations, it is understood that the formation and arrangement of the electrochemical cells 500, 600, 700 may be altered in any appropriate manner to provide the functionality described herein, in a way analogous to the electrochemical cell 300 of FIG. 2.

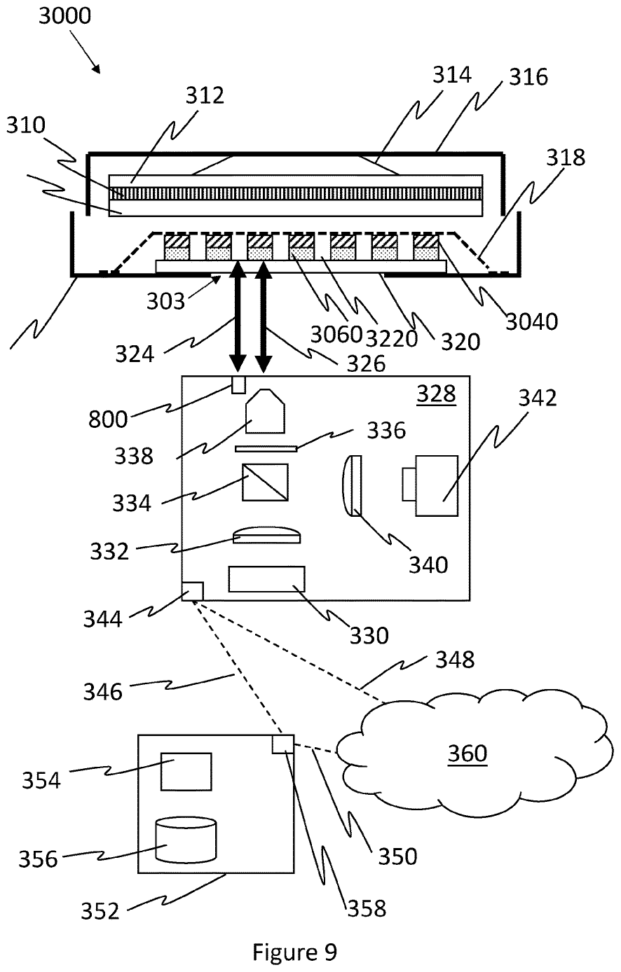

FIG. 9 shows a cross-sectional view of an optically accessible electrochemical cell 3000, with a cell casing 302, aperture 303, transparent window 320 as described above for FIG. 2.

As shown in FIG. 9, above the transparent window 320, there is shown a working electrode layer 3060. The working electrode layer 3060 is a conventional working electrode layer with a high density of active material particles cast upon a foil layer 3040.

Together, the working electrode layer 3060 comprising active material particles and the foil layer 3040 form a working electrode. The foil layer 3040 is an aluminium layer and acts as a foil current collector. In further examples, additionally or alternatively, the foil layer 3040 comprises a different conductive material, such as copper. The working electrode layer 3060 comprises active material particles. In an example, the active material comprises Lithium Cobalt Oxide (LCO). In further examples, the active material comprises Nickel-Manganese-Cobalt Oxide (NMC). In yet further examples, the working electrode layer 3060 comprises any appropriate electrochemical cell material. In examples, additionally, the working electrode layer 3060 comprises additional material, such as conductive additive material and/or binder material.

The working electrode layer 3060 has a circular face with a diameter of 10 mm and is formed on a circular aluminium foil layer 3040 with a thickness of 20 microns. In further examples, the working electrode is formed from a working electrode layer 3060 and foil layer with different shapes and/or dimensions.

The working electrode layer 3060 with active material particles is positioned between the transparent window 320 and the foil layer 3040 of the working electrode such that active material particles are viewable through the transparent window 320. The working electrode layer 3060 comprising active material particles is pressed against the internal face of the transparent window 320 such that the working electrode layer 3060 and the transparent window 320 are in mechanical communication. In further examples, there are one or more further layers between the working electrode layer 3060 and the transparent window 320 such that the functionality described herein is maintained.

Both the working electrode layer 3060 and the foil layer 3040 are shown with a plurality of channels 3220 passing through both the working electrode layer 3060 and the foil layer 3040. The channels 3220 enable electrolyte within the electrochemical cell 3000 to access the working electrode layer 3060. This is in contrast to conventional electrodes, where a foil layer without channels would prevent electrolyte accessing the working electrode layer comprising active material particles when pressed against the transparent window 320.

Whilst the channels 3220 shown in FIG. 9 are shown to extend through the entirety of the height of the working electrode layer 3060 and the foil layer 3040 of the working electrode, in further non-illustrated examples, one or more of the channels 3220 passes partially through the height of the working electrode layer 3060 such that the functionality described herein is preserved.

The interfaces between the transparent window 320 and the channels 3220 provide clean and flat surfaces with a difference in refractive indices that can be used as a reference reflection interface for image focus stabilisation, as described herein. For example, the difference in refractive indices for the glass of the transparent window 320 and electrolyte within the channels 3220 provides an interface location for reflecting a reference beam, as described herein. Further, as the working electrode layer 3060 is mechanically coupled to the transparent window, changes in the position of the reflection interface between the transparent window 320 and the channel 3220 enable the corresponding changes in the surface of the working electrode layer 3060 in the vicinity of the reflection interface to be tracked, thereby providing an input for the imaging focus of the working electrode layer 3060 to be adjusted in the event of any changes in the position of the working electrode layer 3060 (e.g., due to swelling/contraction during operation of the electrochemical cell 3000).

Similarly, during operation, changes in the refractive index of a material, such as an electrolyte, within the channel, change the properties of the interface and hence the reflection of a reference beam directed at the interface. Such a change is indicative of behaviour in the working electrode layer 3060 and may be used to inform an adjustment of an image focus of a portion of the working electrode layer 3060 during an electrochemical process.

The plurality of channels 3220 form circularly cross-sectioned holes through the working electrode, with diameters of 100 microns and a relative linear separation of 300 microns, arranged in a regular square pattern of holes. In further non-illustrated examples, holes of any cross-sectional size and shape form the plurality of channels 3220, in any appropriate regular or irregular formation, or pattern across the working electrode.

A conductive mesh 318 is shown above the foil layer 3040 and is in electrical communication with the lower cell casing 302. The conductive mesh 318 is an aluminium mesh with open holes of 1 mm diameter and narrow ribbons of aluminium metal of 140 microns in width.

Whilst a conductive mesh 318 is shown in FIG. 9, in further non-illustrated examples, a conductive mesh 318 is not included. For example, the working electrode layer 3060 may be in direct electrical contact with the cell casing 302. Alternatively and/or additionally, the transparent window 320 may be at least partially electrical conductive, thereby to provide electrical communication between the working electrode layer 3060 and the cell casing 302.

In further non-illustrated examples, additional and/or alternative material is used to provide electrical connection to the cell casing 302.

Above the mesh 318 there is shown in FIG. 9 a separator 308, a counter electrode 310, a spacer 312 and a spring 314, corresponding to the separator 208, counter electrode 210, spacer 212 and spring 214 described with respect to the conventional electrochemical coin cell 200 of the prior art shown in FIGS. 1A and 1B. The separator 308 is a glass fibre separator and the spacer 312 is a stainless steel spacer. In further non-illustrated examples, additional and/or alternative layers and/or components are implemented.

The stack of layers within the electrochemical cell 3000 is wetted with an electrolyte. In an example, 200 μl of LP57 electrolyte is used. In further examples, a different amount and/or type of electrolyte is used. The layers within the electrochemical cell 3000 are encased with the upper cell casing 316, thereby sealing the electrolyte within the electrochemical cell 3000. The working electrode layer 3060 is optically accessible through the transparent window 320 created within the aperture 303 in the lower cell casing 302.

Whilst the electrochemical cell 3000 is described with respect to particular layers formed in a particular order, in further examples, additional, fewer and/or alternative layers and/or components are used to provide an optically accessible electrochemical cell in accordance with the claimed invention. For example, in further examples, the working electrode is a free-standing electrode layer that does not require a foil layer 3040. In further examples, the working electrode comprises a foil layer 3040 on the surface of the working electrode layer 3060 positioned between the transparent window 320 and the working electrode layer 3060. In such a configuration, the foil layer 3040 comprises one or more apertures, which expose corresponding portions of the working electrode layer 3060, thereby to enable optical access to the working electrode layer 3060 through the foil layer 3040, such that the working electrode layer 3060 is imaged in accordance with the methods described herein.

The cell casing 302, 316 forms a coin cell casing, such as a modified CR2032 coin cell casing. In further examples, the electrochemical cell 3000 has the form of a different coin cell. In further examples, the electrochemical cell 3000 is a different type of cell, such as a pouch cell or a Swagelok™ type cell, and the internal components are arranged analogously whilst providing the benefits described herein.

Electrical connections made to the upper cell casing 316 and the lower cell casing 302 facilitate the application of current-voltage conditions, such as charging and discharging conditions, which cause electrochemical processes to occur within the electrochemical cell 3000. Such electrochemical processes can be imaged by imaging a portion of the working electrode layer 3060 that is optically accessible through the transparent window 320.

Advantageously, the arrangement of the entities in the electrochemical cell 3000 is such that electrolyte can access the active material of the working electrode layer 3060 via the channels 3220, whilst facilitating improved imaging, as described herein. Further, the electrochemical cell 3000 is relatively cost effective, easy to assemble, can be integrated into route battery testing and provide much improved cycling performance compared with known cells.

The working electrode layer 3060 is imaged using an imaging apparatus 328. The imaging apparatus 328 comprises a light source 330 providing light for illuminating/imaging in a direction, as indicated by an arrow 326. The light source is a 532 nm light emitting diode (LED). In further examples, alternative and/or additional light sources, such as laser diodes, lamps and/or LEDs with different peak wavelengths are used for illumination and/or imaging of the working electrode layer 3060.

In order to image the working electrode layer 3060, the electrochemical cell 3000 is held in place in an appropriate location, such as a part of a sample stage. In an example, the imaging apparatus 328 comprises a fixed location for receiving the electrochemical cell 3000 and for making electrical connections to the electrodes of the electrochemical cell 3000, such that appropriate current-voltage conditions can be applied whilst imaging the working electrode layer 3060.

The light source 330 is arranged in order to direct light through an optical microscope comprising a lens system 332, polarising beam splitter 334 or beam splitter, quarter wave plate 336 and objective 338, to an visually exposed portion of the working electrode 306, such that the portion of the working electrode 306 is imaged. Light scattered by the portion of the working electrode layer 306 is then directed through the objective 338, quarter wave plate 336 and by the beam splitter 334, through the lens system 340 to the camera 342, where images of the portion of the working electrode layer 3060 are captured.

Whilst the optical microscope comprises a particular arrangement for imaging the working electrode layer 3060, in further examples, alternative and/or additional optical components are implemented in order to provide imaging focussed on a portion of the working electrode layer 3060 during an electrochemical process.

The imaging apparatus 328 is in communication with a computing device 352 via a communication path 346 between an interface of the imaging apparatus 328 and an interface 358 of the computing device 352. The computing device 352 comprises a processor 354 and a memory 356. The computing device 352 is in communication with a 15 network 360 via a communication path 350 between the computing device 352 and the network 360. The imaging apparatus 328 is also in communication with the network 360 via a communication path 348 and the interface 344 of the imaging apparatus 328.

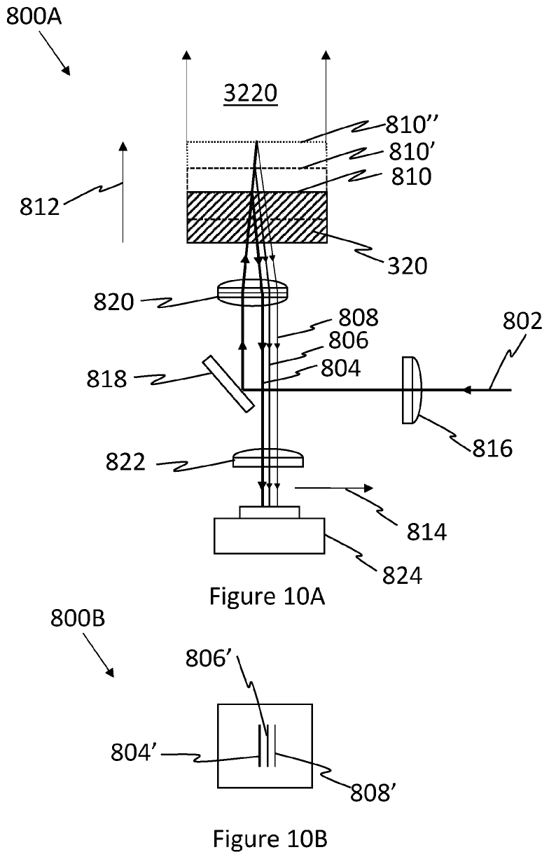

The computing device 352 is in communication with an autofocussing apparatus 800, which is described in further detail with reference to FIG. 10. The autofocussing apparatus 800 is used to direct and measure a reflection of a reference beam 324 from a reflection interface formed in the optically accessible electrochemical cell 3000.

Whilst the imaging apparatus 328 and autofocussing apparatus 800 are shown in communication with a computing device 352 and a network 360, in further non-illustrated embodiments, the imaging apparatus 328 and autofocussing apparatus 800 are implemented and controlled in any suitable manner in accordance with the techniques described herein. In an example, the computing device 352 is integrated into the imaging apparatus 328 and/or autofocussing apparatus 800.

During imaging of a portion of the working electrode layer 3060, it is important to maintain the focus of the surface of the portion of the working electrode layer 3060 that is being imaged. The computing device 352 is configured to communicate with the imaging apparatus 328 and autofocussing apparatus 800 such that the optical components of the imaging apparatus 328 and/or the relative position of the imaging apparatus 328 with respect to the electrochemical cell 3000 are dynamically controlled.

In order to maintain the focus of the surface of the portion of the working electrode layer 3060 that is being imaged, the focal plane of the optical apparatus is adjusted in a direction substantially perpendicular to the surface of the portion of the working electrode layer 3060, which may be substantially perpendicular to the planar surface of the working electrode layer 3060 adjacent to the transparent window 320. In Cartesian coordinates, where the planar surface of the working electrode layer 3060 lies in a plane substantially defined by the x-axis and the y-axis, the focal plane of the optical apparatus is adjusted along the z-axis in order to provide a focussed image of a portion of the working electrode layer 3060.

Whilst a portion of the working electrode layer 3060 initially may be brought into focus by changing the relative position of the focal plane in a direction perpendicular to the z-axis such that the portion coincides with the focal plane of the optical apparatus 328, during real-time operation of the electrochemical cell 3000 by the application of current-voltage conditions, the position of the portion of the working electrode layer 3060 may change, such that it no longer coincides with the focal plane. Such changes can result from the working electrode layer 3060 swelling or contracting during operation, changes in the refractive index of electrolyte within the electrochemical cell 3000 during operation, and changes due to drift in the sample stage supporting the electrochemical cell during operation.

As described above, the high density of active material in conventional electrochemical cell electrodes means that the surface is rough and not suitable for using as a reference point for maintain focus stabilisation, as with dilute electrochemical cell electrodes, where a reference light beam with a suitable spot size is positioned on the relatively smooth and inactive surface between active particles such that changes in the z-position of the dilute electrode can be tracked. Advantageously, the channels 3220 of the optically accessible electrochemical cell 3000 not only provide paths for electrolyte to reach the active material particles of the working electrode layer 3060, but they also provide a reference reflection interface between a portion of the transparent window 320 and a portion of the channel 3220 that can be used to monitor changes in the working electrode layer 3060 that result in changes with respect to the relative difference in position between the portion of the working electrode layer 3060 that is being imaged and the focal plane of the optical apparatus 328 that is being used to image the portion of the working electrode layer 3060.

FIG. 3 shows a process flow S400 for imaging a portion of the working electrode layer 3060 of the optically accessible electrochemical cell 3000 during an electrochemical process. The process flow S400 is performed using the imaging apparatus 328 described with reference to FIG. 9 and/or in other embodiments referenced in the description that provide similar or identical functionality, in order to image a portion of the working electrode layer 3060 of the optically accessible electrochemical cell 3000. The process flow S400 is controlled using a computing device 352 described with reference to FIG. 9. The computing device 352 is used to control the imaging process directly through control of the imaging apparatus 328 and/or indirectly via a computing network 360.

The process is initiated at a first step S402 and moves to step S404, where a portion of the working electrode layer 3060 is imaged. The process may be initiated by a user identifying a portion of the working electrode layer 3060 to image and initiating an experiment to perform an electrochemical process at the electrochemical cell 3000 whilst simultaneously imaging a portion of the working electrode layer 3060 and automatically maintaining focus of the portion of the working electrode layer 3060 that is to be imaged.

In order to image a portion of the working electrode layer 3060, the imaging apparatus 328 is arranged such that the portion of the working electrode layer 3060 is illuminated with light, as shown by the arrow 326 in FIG. 9. The image focus of the imaging apparatus 328 is adjusted such that the focal plane of the imaging apparatus 328 coincides with the portion of the working electrode layer 3060 that is being imaged. An electrochemical process is initiated by applying the appropriate current-voltage conditions to the electrodes 3060, 310 of the electrochemical cell 3000.

An example of an electrochemical process is charging and discharging the electrochemical cell 3000 using CC CV-CC CV cycling protocols at a constant-current (CC) rate of C/5 (nominal 5 hour (dis)charging time) with a constant voltage (CV) of 1 hour. In further examples, different electrochemical processes are instigated.

The process then moves to step S406, where it is determined whether the imaging is complete. The decision to determine whether the imaging is complete or not is optionally based on user intervention, or alternatively and/or additionally, by control of the imaging apparatus 328 based on computer implemented instructions executed by the computing device 352, for example, based on computer implemented instructions stored in the memory 356 of the computing device 352.

If the imaging has not finished, the process moves to step S408, where a reference reflection is monitored. The reference reflection is monitored by the computing device 352 in combination with the imaging apparatus 328. The computing device 352 is integrated into the imaging apparatus 328 in an example. The computing device 352 is configured to implement a hardware or software feedback protocol, for instance a proportional integral derivative (PID) control system such that inputs based on the monitored reflection of a reference beam are processed by the processor 354 in order to determine focussing control of the imaging apparatus 328. Imaging and focus adjustment can occur in series or in parallel. For example, the imaging apparatus 328 can continue to take images of the portion of the working electrode layer 3060 whilst the autofocussing apparatus 800 simultaneously monitors the reference reflection, such that the computing device 352 coordinates the imaging and focus adjustment in any suitable manner.

The reference reflection is monitored by directing focussed radiation at a reference reflection interface comprising a portion of the transparent window 320 and a portion a channel 3220. Advantageously, the reflection interface provides the means for obtaining a clean and consistent reflection that is inextricably linked to the working electrode layer 3060 such that a change in a reflection at the reflection interface is indicative of a change in the working electrode layer 3060. This means, for example, that if the working electrode layer 3060 changes during operation such that the portion being imaged moves out of the focal plane of the imaging apparatus 328, the change in reflection at the reflection interface is used as an input to compensate for the change by adjusting the focal plane of the imaging apparatus 328 in the z-direction substantially perpendicular to the planar surface of the portion of the working electrode layer 3060 that is being imaged, thereby maintaining a stable focus.

The reference reflection is monitored using the optical apparatus 800 described with reference to FIGS. 10A and 10B, in combination with the computing device 352 and/or imaging apparatus 328.

FIG. 10A shows an optical apparatus 800A to enable autofocussing of the imaging apparatus 328, as controlled by the computing device 352, thereby to illustrate the principle of using a reference beam reflected at a reflection interface to determine changes in reflections and to compensate for them accordingly.

There is shown a reference beam 802 from a light source that is directed through a focusing lens 816 and via a mirror 818 through an objective 820 such that it is focussed at a reflection interface. The light source is a collimated low power laser beam with a wavelength of 785 nm. In further examples, any suitable wavelength and power of light source is used to provide a reference beam.

As illustrated with the arrow 324 in FIG. 9, the reference beam is directed at an interface between the transparent window 320 and the channel 3220 passing through the working electrode layer 3060. Advantageously, the channel 3220 may contain electrolyte, thereby simultaneously providing electrolyte to the active material particles of the working electrode layer 3060 whilst also providing a reference point to determine any changes that may alter the image focus of the working electrode layer 3060.

In the example of FIG. 10A, there is shown the transparent window 320 such that there is a reflection interface between the transparent window 320 and the channel 3220 is at a first position 810. The reference beam 802 is focussed at the interface between the transparent window 320 in the first position 810 and the portion of the channel 3220. The reference beam 802 is focussed such that it provides a focus spot at the reflection interface with a Gaussian full width half maximum of 5 to 15 microns. In further examples, a different spot size is used in order to monitor a change at the reflection interface.

A first reflected beam 804 from the reflection interface between the transparent window 320 in the first position 810 and the channel 3220 is directed through the objective 820 and a cylindrical lens 822 to a camera 824, where the first reflected beam 804 provides a reflection line at a first position 804′, as shown in the projection 800B of the x-y plane of a reference beam image captured by the camera 824 at FIG. 10B.

When the transparent window 320 moves in the z-direction 812 such that the reflection interface between the transparent window 320 and the channel 3220 is at a second position 810′, there is a corresponding change in the reflection of the reference beam 802 such that a second reflected beam 806 from the reflection interface formed by the transparent window 320 and the channel 3220 in the second position 810′ provides a reflection line at a second position 806′, as shown in the projection 800B of a reference beam image captured by the camera 824 at FIG. 10B.

The z-direction 812 corresponds to a direction substantially perpendicular to the planar surface of the working electrode layer 3060. Such a change in position of the working electrode layer 3060 occurs, for example, due to electrode swelling or contraction under operating conditions.

When the reflection interface between the transparent window 320 and the channel moves from the second position 810′ to a third position 810″, there is a corresponding change in the reflection of the reference beam 802 such that a third reflected beam 808 from the reflection interface formed by the transparent window 320 and the channel 322 in the third position 810″ provides a reflection line at a third position 808′, as shown in the projection 800B of a reference beam image captured by the camera 824 at FIG. 10B.

As shown at FIG. 10A the lateral position of the reflected beams 804, 806, 808 changes in a lateral direction 814 in the x-y plane, perpendicular to the movement of the interface between the transparent window 320 and the channel 3220 in the z-direction, as a function of the position of the reflection interface between the transparent window 320 and the channel 3220. Accordingly, by monitoring the reflection of the reference beam, changes in the reflection at the reflection interface can be determined and corresponding changes in the working electrode layer 3060 can be taken into account.

Whilst the arrangement of the autofocussing optical apparatus 800A, 800B described with reference to FIGS. 10A and 10B is such that the monitored reflections manifest as lines at the camera 824, in further examples, additional and/or alternative detections of monitored reflections are used to determine changes in the position of the interface between the transparent window 320 and the channel 3220, for example based on changes in position and intensity of detected monitored reflections.

Whilst a particular arrangement of optical components for monitoring a reference beam reflection is described with respect to FIGS. 10A and 10B, in further examples additional and/or alternative optical components are used in order to provide the functionality described herein.

The process then moves to step S410, where it is determined if the reference reflection has changed. If the reference reflection has not changed, the process moves to step S404 the portion of the working electrode layer 3060 is imaged again by the imaging apparatus 328. If it is determined at step S406 that the imaging has finished, the process ends at step S414.

If it is determined at step S410 that the reference reflection has changed, the process moves to step S412, where the image focus of the portion of the working electrode is adjusted, thereby to compensate for changes during the electrochemical process. As the change in the reflection of the reference beam at the reflection interface between the transparent window 320 and the channel 3220 varies as a function of a corresponding change in the working electrode layer 3060, the focal plane of the imaging apparatus 328 is adjusted based on the change in the reflection at the reflection interface, in order to compensate for differences between the position of the focal plane and the portion of the working electrode layer 3060 that is being imaged.

The imaging and monitoring steps of the process flow S400 are repeated for the desired duration of the operation of the electrochemical cell 3000 that is being investigated. Whilst particular steps are shown in the process flow S400, the skilled person understands that in further non-illustrated embodiments, additional and/or alternative steps are implemented, whilst providing the functionality described herein. In further embodiments, the steps of process flow S400 are performed in any manner, simultaneously or sequentially, in order to provide the functionality of adjusting the imaging of a working electrode in response to determining a change in a reference beam reflected at a reflection reference interface described herein.

Advantageously, the arrangement of the electrochemical cell 3000 described with reference to FIG. 9 is such that a portion of the working electrode can be monitored in real time in an improved manner. The rate at which imaging and adjusting image focus occurs is configurable in order to determine desired data.

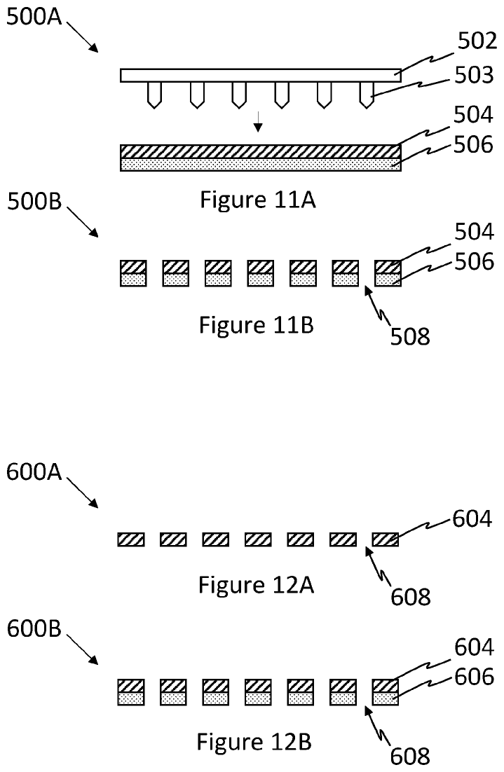

In order to prepare a working electrode layer 3060 and foil layer 3040 with a density of active material particles and channels 3220 that simultaneously facilitates operation within an optically accessible electrochemical cell 3000 whilst enabling improved, stable, imaging, processing steps as described with reference to FIGS. 11 to 13 are undertaken. Cross-sectional examples of the working electrodes are described showing a number of regular channels passing through the working electrodes. In further examples, the working electrode comprises any number of channels formed in any appropriate pattern and/or with any suitable frequency, density and regularity/irregularity. Typically, the working electrodes have a circular planar face for implementation in a coin cell apparatus, however, in further examples, working electrodes comprising channels are formed in any suitable shape and size.

FIGS. 11A and 11B shows a sequence of cross-sectional images as part of a process for forming a perforated working electrode, such as the working electrode layer 3060 with a foil layer 3040 and channels 3220 described herein.

A foil layer 504 is provided with a working electrode layer 506 formed on the foil layer, as shown at FIG. 11A. The foil layer 504 and the working electrode layer 506 are mechanically perforated using a stamp 502 with a plurality of needles 503 to form a plurality of channels 508 through both the foil layer 504 and the working electrode layer 506, as shown at FIG. 11B. Alternatively and/or additionally, the foil layer 504 and the working electrode layer 506 are perforated using laser drilling or laser ablation to introduce channels 508. In further examples, any suitable technique for perforating the foil layer 504 and/or the working electrode layer 506 is used in order to provide a perforated working electrode. Whilst the mechanical perforation using the needles 503 of the stamp 502 are shown to be directed first through the foil layer 504 and then the working electrode layer 504 comprising the active material particles, in further examples the needles 503 of the stamp 502 are directed first through the working electrode layer 506 and then the foil layer 504 in order to preserve a flatter surface of the working electrode layer 506.

FIGS. 12A and 12B shows a sequence of cross-sectional images as part of a process for forming a working electrode, such as the working electrode layer 3060 with a foil layer 3040 and channels 3220 described herein.

A foil or woven wire layer with one or more holes passing through its thickness is provided, such as the mesh foil layer 604, with a plurality of channels 608 through the mesh foil layer 604, as shown at FIG. 12A. Subsequently, a working electrode layer 606 is cast on the mesh foil layer 604, such that a working electrode layer 606 with a plurality of channels 608 is formed, as shown at FIG. 12B.

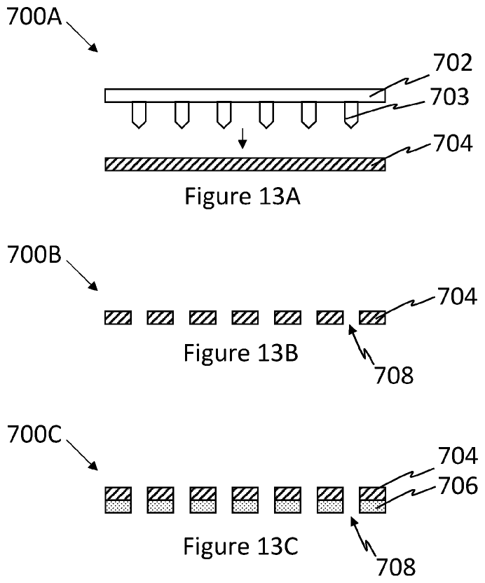

FIGS. 13A to 13C shows a sequence of cross-sectional images as part of a process for forming a working electrode, such as the working electrode layer 3060 with a foil layer 3040 and channels 3220 described herein. A foil layer 704 is provided, along with a stamp 702 comprising a plurality of needles 703, as shown at FIG. 13A. The foil layer 704 is mechanically perforated using the stamp 702 to form a foil layer 704 with a plurality of channels 708, as shown at FIG. 13B. Subsequently, a working electrode is cast on the perforated foil layer 704 to form a working electrode layer 706 with a plurality of channels 708, as shown at FIG. 13C. Alternatively and/or additionally, the foil layer 704 is perforated using laser drilling or laser ablation to introduce channels 708. In further examples, any suitable technique for perforating the foil layer 704 is used in order to provide a mesh upon which a working electrode layer 706 is formed in order to provide a perforated working electrode.

Beneficially, the use of a working electrode with a plurality of channels passing through them means that portions of the working electrode layer that are being imaged can be selected to be a consistent distance away from a point of access of electrolyte (e.g., always a predetermined distance from a hole passing through the working electrode). Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments. It is not limited to the disclosed embodiments and that alternative embodiments could be constructed without departing from the scope of the invention as defined in the appended claims.

### CLAUSES

a. An electrochemical cell comprising:
   a working electrode comprising a channel passing at least partially therethrough;
   a transparent window configured to provide optical access to the working electrode; and
   a reflection interface between a portion of the transparent window and a portion of the channel,
   wherein the reflection interface is configured to change in a manner indicative of a corresponding change in the working electrode.
b. The electrochemical cell according to clause a, comprising:
   a foil layer on a first surface of the working electrode, wherein the transparent window is configured to provide optical access to a second surface of the working electrode positioned opposite to the first surface.
c. The electrochemical cell according to clause a, comprising:
   a foil layer on a first surface of the working electrode, wherein the transparent window is configured to provide optical access to the first surface of the working electrode through one or more apertures in the foil layer.
d. The electrochemical cell according to clause b or c, wherein the foil layer is a current collector and/or a mesh layer.
e. The electrochemical cell according to any preceding clause, wherein the channel extends through the working electrode and the foil layer.
f. The electrochemical cell according to clause a, wherein the working electrode is a free-standing working electrode.
g. The electrochemical cell according to any preceding clause, wherein the channel comprises an electrolyte.
h. The electrochemical cell according to any preceding clause, wherein the working electrode is in mechanical communication with the transparent window.
i. The electrochemical cell according to any preceding clause, wherein the working electrode comprises an active material, preferably wherein an active material loading of the working electrode is at least 80%.
j. The electrochemical cell according to any preceding clause, wherein the electrochemical cell is a coin cell and/or mounted on a printed circuit board.
k. A method for imaging a working electrode during at least part of an electrochemical process, the method comprising:
   monitoring a reflection at an interface between a transparent window and a channel that extends at least partially through the working electrode;
   imaging a portion of the working electrode during at least part of an electrochemical process with an imaging apparatus;
   determining a change in the reflection at the interface; and
   adjusting the image focus of the imaging apparatus in response to determining the change.
l. The method according to clause k, wherein the channel comprises an electrolyte.
m. The method according to clause k or l, wherein monitoring the reflection comprises directing a reference beam at the interface and detecting the position and/or intensity of the reflected reference beam.
n. The method according to any of clauses k to m, wherein imaging the portion of the working electrode comprises imaging a first surface of the working electrode positioned opposite to a second surface of the working electrode, wherein the working electrode comprises a foil layer on the second surface.
o. The method according to any of clauses k to n, wherein adjusting the image focus comprises dynamically altering the focal plane of the imaging apparatus, thereby compensating for changes in the position of the portion of the working electrode in a direction substantially perpendicular to the focal plane.
p. A method of preparing an imaging system for imaging a working electrode during at least part of an electrochemical process in accordance with the method of clauses k to o.
q. The method according to clause p, comprising forming a channel at least partially through the working electrode.
r. The method according to clause q, wherein the channel is formed by forming the working electrode on a foil mesh comprising one or more channels.
s. The method according to clause q, wherein the channel is formed by perforating a foil layer and forming the working electrode on the perforated foil layer.
t. The method according to clause q, wherein the channel is formed by forming the working electrode on a foil layer and subsequently perforating the working electrode.
u. The method according to clauses s or t, wherein perforating comprises the use of at least one of: mechanical perforation; laser drilling; and laser ablation.
w. A system for imaging a working electrode during at least part of an electrochemical process, the system comprising: an imaging apparatus comprising a light source, wherein the system is configured to perform the method of any one of clauses k to o.
x. The system according to clause w, wherein the system comprises an electrochemical cell according to any of clauses a to j.
y. The system according to any of clause w and clause x, wherein the system comprises an electrical connection for receiving a battery electrode.
z. The system according to any of clauses w to y, wherein the light source comprises at least one of: a laser; a light emitting diode; and a lamp, and/or wherein the imaging apparatus comprises an optical microscope.

1. An electrochemical cell comprising:
a working electrode;
a transparent window configured to provide optical access to the working electrode; and
a partially reflective layer comprising one or more regions configured to reflect electromagnetic radiation and one or more regions configured to transmit electromagnetic radiation,
wherein the partially reflective layer is in mechanical communication with the working electrode and configured to change in a manner indicative of a corresponding change in the working electrode, and
wherein the working electrode is in substantially continuous contact with either the transparent window or the partially reflective layer.

2. The electrochemical cell according to claim 1, wherein the partially reflective layer is positioned at least partially between the transparent window and the working electrode.

3. The electrochemical cell according to claim 1, wherein the transparent window is positioned at least partially between the partially reflective layer and the working electrode.

4. The electrochemical cell according to claim 1, wherein the partially reflective layer is at least partially embedded in the working electrode.

5. The electrochemical cell according to claim 1, wherein the partially reflective layer comprises one or more apertures corresponding to the one or more regions configured to transmit electromagnetic radiation, thereby to provide optical access through the partially reflective layer to the working electrodes.

6. The electrochemical cell according to claim 1, comprising one or more layers positioned between the partially reflective layer and the transparent window.

7. The electrochemical cell according to claim 1, wherein the transparent window comprises a passivation layer.

8. The electrochemical cell according to claim 7, wherein the passivation layer is substantially in continuous contact with the partially reflective layer and/or the working electrode.

9. The electrochemical cell according to claim 1, wherein the surface roughness of the reflective layer is less than 100 nm peak to valley.

10. The electrochemical cell according to claim 1, wherein the surface roughness of the reflective layer is less than 10 nm peak to valley.

11. The electrochemical cell according to claim 1, wherein the working electrode is a free-standing working electrode or comprises a porous and conductive material support.

12. The electrochemical cell according to claim 1, wherein the electrochemical cell is a coin cell and/or mounted on a printed circuit board.

13. A method for imaging a working electrode through a transparent window during at least part of an electrochemical process, the method comprising:
monitoring a reflection at a partially reflective layer in mechanical communication with the working electrode;
imaging a portion of the working electrode during at least part of an electrochemical process with an imaging apparatus;
determining a change in the reflection at the partially reflective layer; and
adjusting the image focus of the imaging apparatus in response to determining the change,
wherein monitoring the reflection comprises directing a reference beam at one of one or more regions of the partially reflective layer configured to reflect electromagnetic radiation and imaging the portion of the working electrode comprises imaging through one or more regions of the partially reflective layer configured to transmit electromagnetic radiation; and
wherein the working electrode is substantially in continuous contact with either the transparent window or the partially reflective layer.

14. The method according to claim 13, wherein monitoring the reflection comprises detecting the position and/or intensity of the reflected reference beam.

15. The method according to claim 13, wherein adjusting the image focus comprises dynamically altering the focal plane of the imaging apparatus, thereby compensating for changes in the position of the portion of the working electrode in a direction substantially perpendicular to the focal plane.

16. A method of preparing an imaging system for imaging a working electrode during at least part of an electrochemical process in accordance with the method of claim 13.

17. The method according to claim 16, comprising forming the partially reflective layer on the transparent window and subsequently bringing the transparent window with partially reflective layer substantially into continuous contact with the working electrode.

18. A system for imaging a working electrode during at least part of an electrochemical process, the system comprising:
an imaging apparatus comprising a light source, wherein the system is configured to perform the method of claim 13.

19. The system according to claim 18, wherein the system comprises an electrochemical cell comprising:
a working electrode;
a transparent window configured to provide optical access to the working electrode; and
a partially reflective layer comprising one or more regions configured to reflect electromagnetic radiation and one or more regions configured to transmit electromagnetic radiation,
wherein the partially reflective layer is in mechanical communication with the working electrode and configured to change in a manner indicative of a corresponding change in the working electrode; and
wherein the working electrode is in substantially continuous contact with either the transparent window or the partially reflective layer.

20. (canceled)

21. The system according to claim 18, wherein the light source comprises at least one of: a laser; a light emitting diode; and a lamp, and/or wherein the imaging apparatus comprises an optical microscope.
